(19) United States
(12) Patent Application Publication
(10) Pub. No.: US 2024/0066453 A1
(43) Pub. Date: Feb. 29, 2024

(54) REUSABLE FILTER SYSTEMS AND FRAMES, METHODS OF ASSEMBLING AND TRANSPORTING THE SAME, AND USES THEREOF

(71) Applicant: WONG Kit Fong, Hong Kong (CN)

(72) Inventors: Kit Fong WONG, Hong Kong (CN); Yin Shu MIAO, Hong Kong (CN); Anthony Sze Ming YUEN, Hong Kong (CN)

(21) Appl. No.: 18/547,508

(22) PCT Filed: Feb. 28, 2022
(86) PCT No.: PCT/CN2022/078373

§ 371 Date: Aug. 23, 2023

Related U.S. Application Data
(60) Provisional application No. 63/200,307, filed on Mar. 1, 2021.

(51) Int. Cl. B01D 46/00; B01D 46/52

(52) U.S. Cl. CPC B01D 46/0005; B01D 46/523; B01D 2201/0415; B01D 2201/127

(57) ABSTRACT

A reusable filter system (1000) for a interchangeable pleated filter (1100), comprising: (a) a reusable frame (1200), comprising a first, second, third and fourth holders; (b) at least one flexible sheet (10410), configured to attach to at least a portion of the upper pleat tip face (10101) and/or lower pleat tip face and to extend outward from the first pleated edge (10120) and the second pleated edge (10130); and (c) at least one spline (10310), wherein the first, second, third and fourth holders are configured to be reversibly connected with each other to form the reusable frame (1200), and wherein each of the first, second, third and fourth holders further comprises a spline (10310) receiving portion sized and shaped to receive the spline (10310).

### CROSS-REFERENCE TO RELATED APPLICATION

This application claims priority to, and the benefit of, U.S. Provisional Application having Ser. No. 63/200,307 filed on Mar. 1, 2021. The entire contents of the foregoing application are hereby incorporated by reference in its entirety for all purposes.

### FIELD OF INVENTION

This application relates to air filter systems. More particularly, this application relates to reusable air filter systems.

### BACKGROUND OF INVENTION

Certain traditional air filter cartridges may include a filter element, a frame, and a metal grid. These filter cartridges are designed to be disposable and environmentally unfriendly. The filtration media are usually pleated to provide greater surface area on which to collect particulates, but prone to deformation due to the force of air passing through the media. Besides, pleated filter cartridges occupy a large volume of empty space per filter due to the shape of the pleated media and causes high transportation costs. In addition, pleated filter materials are soft and prone to deformation (e.g., by back pressure created by high air flow), and any by-pass air flow from the edges and sides of the pleated filter will affect the filtration efficiency. Accordingly, there is a need for new filter systems and frames, and methods of making and transporting the same.

### SUMMARY OF INVENTION

Disclosed herein are novel frame and systems that are useful for air filtering, processes for preparing the reusable frame and reusable filter systems, and methods of packaging the same for transportation and methods of making the same.

In certain embodiments, provided is a reusable filter system, comprising: (a) an interchangeable filter material having a plurality of pleats, each pleat having a pleat height, a pleat width and a cross-section defining a pleat profile, the filter having a first pleated edge generally perpendicular to a direction of pleating and an opposing, second pleated edge defining a variable filter width, and a first side generally parallel to the direction of pleating and an opposing, second side defining a filter length; and (b) a reusable frame, comprising: (i) a first holder sized and shaped to cover and support each of the plurality of pleats along the first pleated edge; (ii) a second holder sized and shaped to cover and support each of the plurality of pleats along the second pleated edge; (iii) a first linker connectable with the first and second holders along the first side; and (iv) a second linker connectable with the first and second holders along the second side; and (v) a third holder sized and shaped to support the plurality of pleats proximate to a middle position between the first pleated edge and the second pleated edge, the first and the second linkers are further configured to be connectable with the third holder at the middle position, wherein the filter is collapsed when the system is in a dissembled state, and wherein each of the first and second linkers is connected with the first and second holders to form a cavity therein to receive the filter, and the first holder, the second holder and the third holder interact with the plurality of pleats to secure a spaced, pleated structure of the filter when the system is in an assembled state. In a further embodiment, the first linker and the second linker are retractable such that the frame can be expanded to receive the filter and collapsed to minimize the size of the frame.

In certain embodiments, provided is a reusable filter system, comprising: (a) an interchangeable filter material having a plurality of pleats, each pleat having a pleat height, a pleat width and a cross-section defining a pleat profile, the filter having a first pleated edge generally perpendicular to a direction of pleating and an opposing, second pleated edge defining a variable filter width, and a first side generally parallel to the direction of pleating and an opposing, second side defining a filter length; and (b) a reusable frame, comprising: (i) a first holder sized and shaped to cover and support each of the plurality of pleats along the first pleated edge; (ii) a second holder sized and shaped to cover and support each of the plurality of pleats along the second pleated edge; (iii) a first linker connectable with the first and second holders along the first side; and (iv) a second linker connectable with the first and second holders along the second side; and (v) a third holder sized and shaped to support the plurality of pleats proximate to a middle position between the first pleated edge and the second pleated edge, the first and the second linkers are further configured to be connectable with the third holder at the middle position, wherein the first, the second and the third holders and the first linker, and the second linker are zigzag shaped fit for stacking on each other and the filter is collapsed when the system is in a dissembled state, and wherein each of the first and second linkers is connected with the first and second holders to form a cavity therein to receive the filter, and the first holder, the second holder and the third holder interact with the plurality of pleats to secure a spaced, pleated structure of the filter when the system is in an assembled state.

In certain embodiments, provided is a reusable filter system, comprising: (a) an interchangeable filter having a plurality of pleats, each pleat having a pleat height, a pleat width and a cross-section defining a pleat profile, the filter having a first pleated edge generally perpendicular to a direction of pleating and an opposing, second pleated edge, a first side generally parallel to the direction of pleating and an opposing, second side, and an upper pleat tip face and an opposing, lower pleat tip face; and

(b) a reusable frame, comprising: (i) a first holder sized and shaped to hold the plurality of pleats along the first pleated edge; (ii) a second holder sized and shaped to hold the plurality of pleats along the second pleated edge; (iii) a third holder sized and shaped to hold the plurality of pleats along the first side; and (iv) a fourth holder sized and shaped to hold the plurality of pleats along the second side; (v) at least one pleat spacer connectable with the frame, wherein the first, second, third and fourth holders are configured to be reversibly connected with each other to form the reusable frame having a cavity therein to receive the filter when the system is in an assembled state, and wherein each of the at least one pleat spacer comprising a plurality of spacer elements being sized and shaped to match with the plurality of pleats such as to maintain a spaced, pleat profile of the filter when the system is in the assembled state.

In some embodiments, provided is a reusable frame for an interchangeable pleated filter, the filter having a plurality of pleats, each pleat having a pleat height, a pleat width and a cross-section defining a pleat profile, the filter having a first pleated edge generally perpendicular to a direction of pleating and an opposing, second pleated edge, a first side generally parallel to the direction of pleating and an opposing, second side, and an upper pleat tip face and an opposing, lower pleat tip face, the filter further comprising at least one flexible sheet, configured to attach to at least a portion of the upper pleat tip face and/or lower pleat tip face and to extend outward from the first pleated edge and the second pleated edge to form a first pleated edge extension and a second pleated edge extension, respectively, the reusable frame comprising: (i) a first holder sized and shaped to hold the plurality of pleats along the first pleated edge; (ii) a second holder sized and shaped to hold the plurality of pleats along the second pleated edge; (iii) a third holder sized and shaped to hold the plurality of pleats along the first side; (iv) a fourth holder sized and shaped to hold the plurality of pleats along the second side; and (v) at least one pleat spacer connectable with the frame, wherein the first, second, third and fourth holders are configured to be reversibly connected with each other to form the reusable frame having a cavity therein to receive the filter when the system is in the assembled state, and wherein each of the at least one pleat spacer comprising a plurality of spacer elements being sized and shaped to match with the plurality of pleats such as to maintain a spaced, pleat profile of the filter when the system is in the assembled state.

In some embodiments, provided is a method of assembling a reusable filter system for an interchangeable pleated filter, comprising the steps of: (a) providing the aforementioned reusable filter system comprising a reusable frame; (b) assembling the reusable frame partially or entirely by connecting first, second, third and fourth holders together and installing at least one pleat spacer to the reusable frame; (c) installing the interchangeable pleated filter to the reusable frame; (d) assembling the reusable frame entirely if the same is partially assembled; and (e) installing the at least one spline into spline receiving portion of the reusable frame.

In some embodiments, provided is a method of transporting the reusable filter system, comprising the steps of: (a) providing the aforementioned reusable filter system in an disassembled state; (b) packaging the interchangeable pleated filter in a collapsed state and/or the reusable filter system in a dissembled state into one or more packaging containers to form at least one finished packaging, such that volume of space of the finished packaging is significantly reduced; (c) delivering the finished packaging to a location for use; and (d) assembling the reusable filter system for use. In some embodiments, provided is a use of the reusable filter system of any one of the embodiments described herein in an air filtration system. In some embodiments, provided is a method of air filtration using the reusable filter system of any one of the embodiments described herein, comprising the step of applying the reusable filter system to an air filtration system.

There are many advantages of the invention. In certain embodiments, at least certain components of the filter systems, such as the frame of the novel filter systems and the frames are reusable for a long period of time, thus is environmentally friendlier. In certain embodiments, the novel systems may be easily adapted to any air filtration systems such as air conditioning and mechanical ventilation (ACMV), AHU/PAU, central MVAC and/or VRV/split systems. In certain embodiments, the novel systems are extendable and can adapt to different dimensions. In certain embodiments, the novel systems provide a strong mechanical protection to the filter media. In certain embodiments, the novel systems maintain the pleated structure or geometry of the filter media, providing greater surface area to collect particulates. In certain embodiments, the novel systems provide reversible connection design such as slot-in, snap-in or inter-locking to facilitate the change or fixing the filter. In certain embodiments, the novel systems provide better filtration efficiency while keeping low pressure drop because the spaced, pleated structure of the filter is maintained. In certain embodiments, the novel systems maximize the surface area within a fixed frame size. In certain embodiments, the novel systems in a dissembled state provide seamless pleat packs, significantly reduce the volume of space, thus reducing the transportation costs. In certain embodiments, the novel frames are easy to assemble and disassemble, facilitating change of filters. In certain embodiments, the reusable frames and systems are universal and can adopt to various sizes and applications. In certain embodiments, at least some of the components (such as holders and pleat spacers) of the reusable frames and systems are collapsible, retractable or can be dissembled into compact packaging, which is advantageous for packaging, shipping and/or storage. In certain embodiments, the systems and frames are user-friendly and easy to assemble or disassemble. In certain embodiments, provided reusable systems and frames provide good mechanical support to the filter. In certain embodiments, various features of reusable systems and frames ensures good securing or fixing the edges and sides of the pleated filter, avoiding air directly by-pass or leakage from the edges or sides. In certain embodiments, various features of reusable systems and frames provides good support to the filter to withstand back pressure and avoid deformation, especially for applications requiring high air flow volume, such as but not limited to AHU system. In certain embodiments, various features of reusable systems and frames regulate or maintain pleat spacing to maximize the filtration efficiency.

### BRIEF DESCRIPTION OF FIGURES

FIGS. 1A-1F are schematic diagrams which illustrate a reusable filter system of an example embodiment, wherein FIG. 1A-1C show a reusable system (with filter material), and FIG. 1D-1F show a reusable frame without filter material.

FIGS. 2A-2B are schematic diagrams which illustrate a reusable filter system of another example embodiment.

FIGS. 3A-3B are schematic diagrams which illustrate a step of packing filter system in a method of transporting a filter system of an example embodiment.

FIGS. 4A-4B are schematic diagrams which illustrate a step of packing filter material in a method of transporting a filter system of another example embodiment.

FIGS. 5A-5B are schematic diagrams which illustrate a step of packing filter material in a method of transporting a filter system of another example embodiment.

FIGS. 6A-6B are schematic diagrams which illustrate a step of packing filter material in a method of transporting a filter system of another example embodiment.

FIGS. 7A-7B are schematic diagrams which illustrate a reusable filter system of an example embodiment.

FIG. 7C is a schematic diagram which illustrates a reusable frame of the reusable filter system according to the sane example embodiment of FIG. 7A.

FIG. 7D is a schematic diagram which illustrates the connection between two holders via a frame connector in a reusable filter system according the same example embodiment as shown in FIG. 7A.

FIG. 7E is a cross-sectional of the first holder according the same example embodiment as shown in FIG. 7A.

FIG. 7F is a cross sectional view of the third holder according the same example embodiment as shown in FIG. 7A.

FIG. 7G is a schematic diagram which illustrates the interaction between a pleat spacer, a filter and a third holder in the reusable filter system according to the same example embodiment as shown in FIG. 7A when the system is in an assembled state.

FIG. 8 is a schematic diagram which illustrates the interaction between a pleat spacer, a filter and a third holder in a reusable filter system according to another example embodiment when the system is in an assembled state.

FIG. 9A is a schematic diagram which illustrate a reusable filter system of another example embodiment.

FIG. 9B is a schematic diagram which illustrates the connection between two holders via a frame connector in a reusable filter system according the same example embodiment as shown in FIG. 9A.

FIG. 9C is a cross-sectional view of a first holder according the same example embodiment as shown in FIG. 9A.

FIG. 9D is a cross-sectional view of a third holder according the same example embodiment as shown in FIG. 9A.

FIGS. 10A-10D are schematic diagrams which illustrate a reusable filter system of an example embodiment.

FIGS. 10E-10F are schematic diagrams which illustrate a collapsible supporting piece connected with a first linker and a second linker of the reusable filter system according to the same example embodiment as shown in FIG. 10A in a collapsed state and an expanded state respectively.

FIG. 10G shows a close-up partial exploded view of a flexible cover and a filter of the reusable filter system according to the same example embodiment as shown in FIG. 10A.

FIG. 10H shows a close-up perspective view of a spline of the reusable filter system according to the same example embodiment as shown in FIG. 10A.

FIG. 10I is a schematic cross-sectional diagram which illustrates the interaction between a spline, a third holder and a filter along the first side of the filter according to the same example embodiment as shown in FIG. 10A.

FIG. 10J is a schematic cross-sectional diagram which illustrates the interaction between a spline, a second holder, a flexible cover and a filter along the second pleated edge of the filter according to the same example embodiment as shown in FIG. 10A.

FIG. 10K is a schematic diagram which illustrates the connection between a second holder and a fourth holder via a frame connector in a reusable filter system according the same example embodiment as shown in FIG. 10A.

FIGS. 11A-11C are schematic diagrams which illustrate a reusable filter system of an example embodiment.

FIG. 11D-11E are schematic diagrams which illustrate a supporting piece and a fourth holder in the reusable filter system when they are separated from and connected with each other respectively according to the same example embodiment as shown in FIG. 11A.

FIGS. 12A-12B are schematic diagrams which illustrate a reusable filter system of an example embodiment.

FIG. 12C shows a close-up view of a flexible sheet and a filter of the reusable filter system according to the same example embodiment as shown in FIG. 12A.

FIG. 12D shows a close-up view of a spline of the reusable filter system according to the same example embodiment as shown in FIG. 10A.

FIG. 12E is a schematic diagram which illustrates the interaction between a spline, a third holder and a filter along the first side of the filter according to the same example embodiment as shown in FIG. 12A.

FIG. 12F is a schematic cross-sectional diagram which illustrates the interaction between a spline, a second holder, a flexible sheet, and a filter along the first pleated edge of the filter according to the same example embodiment as shown in FIG. 12A.

FIGS. 13A-13B are schematic diagrams which illustrate a reusable filter system of an example embodiment.

FIG. 13C is a cross-sectional view of a second holder in a reusable filter system according to the same example embodiment as shown in FIG. 13A.

FIG. 14A shows a method of assembling a filter system and reusable frame according to an example embodiment.

FIG. 14B shows a method of assembling a filter system and reusable frame according to another example embodiment.

FIG. 15 shows a method of packaging the reusable filter system for transportation according to an example embodiment.

FIG. 16 is a schematic diagram which illustrates a step of packing filter system in a method of transporting a filter system of an example embodiment.

FIGS. 17A and 17B are schematic diagrams which illustrate steps of packing filter system in a method of transporting a filter system of example embodiments.

### DETAILED DESCRIPTION

As used herein and in the claims, “comprising” and “including” mean including the following elements but not excluding others.

As used herein and in the claims, the terms “comprising” (or any related form such as “comprise” and “comprises”), “including” (or any related forms such as “include” or “includes”), “containing” (or any related forms such as “contain” or “contains”), or “having” (or any related forms such as “have” or “has”) means including the following elements but not excluding others. It shall be understood that for every embodiment in which the term “comprising” (or any related form such as “comprise” and “comprises”), “including” (or any related forms such as “include” or “includes”), or “containing” (or any related forms such as “contain” or “contains”) is used, this disclosure/application also includes alternate embodiments where the term “comprising”, “including,” “containing,” or “having” is replaced with “consisting essentially of”′ or “consisting of”. These alternate embodiments that use “consisting of” or “consisting essentially of” are understood to be narrower embodiments of the “comprising”, “including,” or “containing,” embodiments.

For example, alternate embodiments of “a solution comprising A, B, and C” would be “a solution consisting of A, B, and C” and “a solution consisting essentially of A, B, and C.” Even if the latter two embodiments are not explicitly written out, this disclosure/application includes those embodiments. Furthermore, it shall be understood that the scopes of the three embodiments listed above are different.

For the sake of clarity, “comprising”, including, and “containing”, and any related forms are open-ended terms which allows for additional elements or features beyond the named essential elements, whereas “consisting of” is a closed end term that is limited to the elements recited in the claim and excludes any element, step, or ingredient not specified in the claim.

“Essentially consisting of” limits the scope of a claim to the specified materials, components, or steps (“essential elements”) that do not materially affect the essential characteristic(s) of the claimed invention. In some embodiments, the essential characteristics are the basic and novel characteristic(s) of the claimed invention.

As used herein, the singular forms “a”, “an” and “the” are intended to include the plural forms as well, unless the context clearly indicates otherwise. Where a range is referred in the specification, the range is understood to include each discrete point within the range. For example, 1-7 means 1, 2, 3, 4, 5, 6, and 7.

As used herein, the term “about” is understood as within a range of normal tolerance in the art and not more than ±10% of a stated value. By way of example only, about 50 means from 45 to 55 including all values in between. As used herein, the phrase “about” a specific value also includes the specific value, for example, about 50 includes 50.

As used herein and in the claims, “filter” means fibrous material(s), media, devices or elements which removes particulates or contaminants (such as dust, pollen, mold, and bacteria) from the air. In certain embodiments, the filter may be reusable (e.g., after cleaning and/or disinfection). In other embodiments, the filter may be disposable.

As used herein and in the claims, “pleat” means repeated structures.

As used herein and in the claims, “pleated filter” refers to a filter material repeated multiple times, such as by folding or joining multiple repeated units together. In certain examples, the folding is in a zig-zag manner to form a plurality of pleats. In certain examples, “pleated filter” also includes bag filters which forms by series of multiple pouch-like filters. In certain examples, “pleated filter” is reversibly collapsible and expandable air filter element.

As used herein and in the claims, “flexible” means deformable, or able to be bent.

As used herein and in the claims, “rigid” means lacking flexibility or difficult to be deformed or bent by a user during normal use. The degree of rigidity can vary, as long as the rigidity does not interfere with the overall functionality of the frame or system.

As used herein and in the claims, “frame” means a structure providing support. In certain examples, the frame is in the form of a closed structure having an overall rectangular shape.

As used herein and in the claims, “spline” means an elongated, flexible cord. In certain embodiments, the spline may be made by extrusion process.

As used herein and in the claims, “engagable” means able to interlock.

As used herein and in the claims, “attach”, “attached”, “attaching” refers to physical binding or connecting with other elements either directly or indirectly.

As used herein and in the claims, “connect”, “connected”, “connecting” refers to with joining or linking other elements either directly or indirectly.

As used herein and in the claims, “secure”, “securing” means holding fast.

For the sake of convenience and clarity, the spatial terms such as “vertical”, “horizontal”, “vertical”, “horizontal”, “upper”, “lower”, “left”, and “right” etc. may be used herein with respect to the drawings. However, the systems and frames can be used in many directions and positions, and these terms are not intended to be limiting and/or absolute.

As used herein and in the claims, terms “first”, “second”, “third”, “fourth” etc. may be used herein to describe various limitations, elements, components, regions, layers and/or sections, these limitations, elements, components, regions, layers and/or sections should not be limited by these terms. These terms are only used to distinguish one limitation, element, component, region, layer or section from another limitation, element, component, region, layer or section. Thus, a first limitation, element, component, region, layer or section discussed below could be termed a second limitation, element, component, region, layer or section without departing from the teachings of the present application.

As used herein and in the claims, “inner” or “interior” will refer to the direction towards the center of an object (e.g., the filter) and the term “outer” or “exterior” will refer to the direction opposite to the center.

For the convenience of description, all subsequent drawings with the same reference numeral refer to the same part, and will not be repeated in the description of each drawing.

### NUMBERED EMBODIMENTS

Set 1
1. A reusable filter system, comprising:
   (a) an interchangeable filter material having a plurality of pleats, each pleat having a pleat height, a pleat width and a cross-section defining a pleat profile, the filter having a first pleated edge generally perpendicular to a direction of pleating and an opposing, second pleated edge, and a first side generally parallel to the direction of pleating and an opposing, second side; and
   (b) a reusable frame, comprising:
      (i) a first holder sized and shaped to cover and support each of the plurality of pleats along the first pleated edge;
      (ii) a second holder sized and shaped to cover and support each of the plurality of pleats along the second pleated edge;
      (iii) a first linker connectable with the first and second holders along the first side; and
      (iv) a second linker connectable with the first and second holders along the second side; and
      (v) a third holder sized and shaped to support the plurality of pleats proximate to a middle position between the first pleated edge and the second pleated edge, the first and the second linkers are further configured to be connectable with the third holder at the middle position,
   wherein the first, the second and the third holders and the first linker, and the second linker are zigzag shaped fit for stacking on each other and the filter is collapsed when the system is in a dissembled state, and
   wherein each of the first and second linkers is connected with the first holder, the second holder and the third holder to form a cavity therein to receive the filter, and the first and the second holders interact with the plurality of pleats to secure a spaced, pleated structure of the filter when the system is in an assembled state.
2. A reusable filter system, comprising:
   (a) an interchangeable filter material having a plurality of pleats, each pleat having a pleat height, a pleat width and a cross-section defining a pleat profile, the filter having a first pleated edge generally perpendicular to a direction of pleating and an opposing, second pleated edge, and a first side generally parallel to the direction of pleating and an opposing, second side; and
   (b) a reusable frame, comprising:
      (i) a first holder sized and shaped to cover and support each of the plurality of pleats along the first pleated edge;
      (ii) a second holder sized and shaped to cover and support each of the plurality of pleats along the second pleated edge;
      (iii) a first linker connectable with the first and second holders along the first side; and
      (iv) a second linker connectable with the first and second holders along the second side; and
      (v) a third holder sized and shaped to support the plurality of pleats proximate to a middle position between the first pleated edge and the second pleated edge, the first and the second linkers are further configured to be connectable with the third holder at the middle position,
   wherein the first, the second and the third holders and the first and second linkers are shaped fit for staggering on each other and the filter is collapsed when the system is in a dissembled state, and
   wherein each of the first and second linkers is connected with the first and second holders to form a cavity therein to receive the filter, and the first and the second holders interact with the plurality of pleats to secure a spaced, pleated structure of the filter when the system is in an assembled state.
3. A method of preparing a filter system, comprising the steps of:
   (a) providing a filter material comprising a plurality of pleats, each pleat having a pleat height, a pleat width and a cross-section defining a pleat profile, the filter having a first pleated edge generally perpendicular to a direction of pleating and an opposing, second pleated edge defining a variable filter width, and a first side generally parallel to the direction of pleating and an opposing, second side defining a filter length;
   (b) providing a reusable frame, the frame comprising a first holder sized and shaped to cover and support each of the plurality of pleats along the first pleated edge; a second holder sized and shaped to cover and support each of the plurality of pleats along the second pleated edge; a first linker connectable with the first and second holders along the first side; and a second linker connectable with the first and second holders along the second side;
   (c) when the system is in an disassembled state, packaging the filter in a collapsed form and the holders and frames in staggered or stacking arrangement, and when the system is in assembled state, assembling the filter and the frame forming from the holders and linkers, such that the first and the second holders interact with the plurality of pleats to secure a spaced, pleated structure of the filter.
4. A method of transporting the filter system, comprising the steps of:
   (a) providing the filter system of embodiment 1 or embodiment 2 in an disassembled state;
   (b) packaging the filter material in a collapsed form and/or the holders and linkers in a compact form on each other into either one combined or separate packaging containers to form a finished packaging, such that volume of space in the finished packaging is significantly reduced;
   (c) delivering the finished packaging to a location for use;
   (d) assembling the filter and the frame into filter system for use.
Set 2
1. A reusable filter system for a interchangeable pleated filter having a plurality of pleats, each pleat having a pleat height, a pleat width and a cross-section defining a pleat profile, the filter having a first pleated edge generally perpendicular to a direction of pleating and an opposing, second pleated edge, a first side generally parallel to the direction of pleating and an opposing, second side, and an upper pleat tip face and an opposing, lower pleat tip face, the filter system comprising:
   (a) a reusable frame, comprising:
      (i) a first holder sized and shaped to hold the plurality of pleats along the first pleated edge;
      (ii) a second holder sized and shaped to hold the plurality of pleats along the second pleated edge;
      (iii) a third holder sized and shaped to hold the plurality of pleats along the first side; and
      (iv) a fourth holder sized and shaped to hold the plurality of pleats along the second side;
   (b) at least one flexible sheet, configured to attach to at least a portion of the upper pleat tip face and/or lower pleat tip face and to extend outward from the first pleated edge and the second pleated edge to form a first pleated edge extension and a second pleated edge extension, respectively; and
   (c) at least one spline,
   wherein the first, second, third and fourth holders are configured to be reversibly connected with each other to form the reusable frame having a cavity therein to receive the filter when the system is in an assembled state, and
      wherein each of the first, second, third and fourth holders further comprises a spline receiving portion sized and shaped to receive the spline, such that the spline receiving portion of each of the first, second, third and fourth holders can frictionally retain the first pleated edge extension, the second pleated edge extension, the first side and the second side therein respectively, when the at least one spline is installed into the spline receiving portion.
2. The reusable filter system of embodiment 1, wherein the at least one flexible sheet is at least partially air permeable.
3. The reusable filter system of embodiment 1 or 2, wherein the at least one flexible sheet is fixedly attached to the filter by adhesive, thermal bonding and/or ultrasonic welding.
4. The reusable filter system of embodiment 1 or 2, wherein the at least one flexible sheet is a continuous sheet sized and shaped sufficient to cover entire upper pleat tip face or entire lower pleat tip face and to extend outwardly from the first pleated edge and the second pleated edge.
5. The reusable filter system of any one of the preceding embodiments, wherein the at least one flexible sheet comprises a first flexible sheet and a second flexible sheet, the first flexible sheet is sized and shaped sufficient to cover entire upper pleat tip face or entire lower pleat tip face and to extend outwardly from the first pleated edge, and the second flexible sheet is sized and shaped sufficient to cover entire upper pleat tip face or entire lower pleat tip face and to extend outwardly from the second pleated edge.
6. The reusable filter system of any one of the preceding embodiments, wherein all the spline receiving portions together form a continuous spline channel for receiving the spline, when the system is in the assembled state.
7. The reusable filter system of any one of the preceding embodiments, wherein each spline receiving portion further comprises at least one ridge to frictionally limit the spline therein.
8. The reusable filter system of any one of the preceding embodiments, wherein the spline further comprises a spline flap piece extended along a longitudinal length of the spline to limit the first pleated edge, the second pleated edge, the first side and/or the second side within the frame, when the system is in the assembled state.
9. The reusable filter system of embodiment 8, wherein the spline further comprising a neck portion connecting the spline and the spline flap piece.
10. The reusable filter system of embodiment 9, wherein the neck portion further comprises at least one dent, and the spline receiving portion further comprising at least one ridge sized and shaped to match with the corresponding dent to limit the spline in the spline receiving portion.
11. The reusable filter system of any one of the preceding embodiments, further comprising at least one pleat spacer connectable with the frame, wherein each of the at least one pleat spacer comprising a plurality of spacer elements being sized and shaped to match with the plurality of pleats such as to maintain a spaced, pleat profile of the filter when the system is in the assembled state.
12. The reusable filter system of embodiment 11, wherein number of the spacer element generally match with the number of pleats, and each spacer element has a spacer element width that generally matches with the pleat width.
13. The reusable filter system of embodiment 11 or 12, wherein the at least one pleat spacer is provided in form of a spring connectable with the third holder and the fourth holder and the plurality of spacer elements are provided in form of a plurality of coils, each sized and shaped to match with the pleat width.
14. The reusable filter system of embodiment 11 or 12, wherein the at least one pleat spacer is provided in form of a zig-zag shaped piece that generally follows at least a portion of the pleat profile.
15. The reusable filter system of embodiment 1, wherein
   the first holder comprises a pair of first clamps, each first clamp has an engaging surface with a shape generally matching the pleat profile along the first pleated edge and are complimentarily engageable with each other; and
   the second holder comprises a pair of second clamps, each second clamp has an engaging surface with a shape generally matching the pleat profile along the second pleated edge and are complimentarily engageable with each other,
   such that at least a portion of filter along the first pleated edge and the second pleated edge are clipped between the first and the second clamps when the system is in the assembled state.
16. The reusable filter system of embodiment 1, wherein
   the first holder comprises a first plate and a plurality of spaced first teeth extending perpendicularly from a longitudinal side of the first plate; and/or
      the second holder comprises a second plate and a plurality of spaced second teeth extending perpendicularly from a longitudinal side the second plate,
      wherein a spacing between two adjacent first and/or second teeth is configured to match with the respective pleat width and the teeth height is configured to match with respective pleat height such as to maintain a spaced pleat profile along the first side and/or the second side.
17. The reusable filter system of any one of the embodiments 11-14, wherein the pleat spacer comprises a spacer plate and a plurality of spaced spacer teeth extending perpendicularly from a longitudinal side the spacer plate, wherein a spacing between two adjacent spacer teeth is configured to match with the respective pleat width and the teeth height is configured to match with respective pleat height.
18. The reusable filter system of any one of the embodiments 11-14, wherein the at least one pleat spacer is configured to be connectable with the third holder and the fourth holder.
19. The reusable filter system of any one of the preceding embodiments, wherein the reusable frame further comprises a plurality of connectors, each connector is configured to be reversibly connecting two ends of any two of the first, second, third and fourth holders together.
20. The reusable filter system of any one of the preceding embodiments, further comprising at least one supporting piece connecting to the frame.
21. The reusable filter system of embodiment 20, wherein the at least one supporting piece is configured to connect between the third holder and the fourth holder.
22. The reusable filter system of embodiment 20 or 21, wherein the at least one supporting piece is a rigid rod comprising a rectangular, trough or trapezoid cross-section.
23. The reusable filter system of any one of the embodiments 20-22, wherein the at least one supporting piece is one or more pairs of cross pieces pivotally connected with each other in one direction, each pair of the cross pieces are pivotally connected at a central coupling point, wherein the one or more pairs of cross pieces are configured to connect the third and the fourth holders so that the third and the fourth holders can be switched between an assembling position and a dissembling position.
24. A reusable frame for an interchangeable pleated filter, the filter having a plurality of pleats, each pleat having a pleat height, a pleat width and a cross-section defining a pleat profile, the filter having a first pleated edge generally perpendicular to a direction of pleating and an opposing, second pleated edge, a first side generally parallel to the direction of pleating and an opposing, second side, and an upper pleat tip face and an opposing, lower pleat tip face, the filter further comprising at least one flexible sheet, configured to attach to at least a portion of the upper pleat tip face and/or lower pleat tip face and to extend outward from the first pleated edge and the second pleated edge to form a first pleated edge extension and a second pleated edge extension, respectively, the reusable frame comprising:
   (i) a first holder sized and shaped to hold the plurality of pleats along the first pleated edge;
   (ii) a second holder sized and shaped to hold the plurality of pleats along the second pleated edge;
   (iii) a third holder sized and shaped to hold the plurality of pleats along the first side; and
   (iv) a fourth holder sized and shaped to hold the plurality of pleats along the second side,
   wherein the first, second, third and fourth holders are configured to be reversibly connected with each other to form the reusable frame having a cavity therein to receive the filter when the system is in the assembled state, and wherein each of the first, second, third and fourth holders further comprises a spline receiving portion sized and shaped to receive a spline, such that the spline receiving portion of each of the first, second, third and fourth holders can frictionally retain the first pleated edge extension, the second pleated edge extension, the first side and the second side therein respectively, when the at least one spline is installed into the spline receiving portion.
25. The reusable frame of embodiment 24, wherein all the spline receiving portions together form a continuous spline channel for receiving a spline, when the system is in the assembled state.
26. The reusable frame of embodiment 24 or 25, wherein each spline receiving portion further comprises at least one ridge to frictionally limit the spline therein.
27. The reusable frame of any one of the embodiments 24-26, wherein the spline receiving portion further comprising at least one ridge sized and shaped to match with at least one dent of the spline to limit the spline in the spline receiving portion.
28. The reusable frame of any one of embodiments 24-27, further comprising at least one pleat spacer connectable with the frame, wherein each of the at least one pleat spacer comprising a plurality of spacer elements being sized and shaped to match with the plurality of pleats such as to maintain a spaced, pleat profile of the filter when the system is in an assembled state.
29. The reusable frame of embodiment 28, wherein number of the spacer element generally match with the number of pleats, and each spacer element has a spacer element width that generally matches with the pleat width.
30. The reusable frame of embodiment 28 or 29, wherein the at least one pleat spacer is provided in form of a spring connectable with the third holder and the fourth holder and the plurality of spacer elements are provided in form of a plurality of coils, each sized and shaped to match with the pleat width.
31. The reusable frame of embodiment 28 or 29, wherein the at least one pleat spacer is provided in form of a zig-zag shaped piece that generally follows at least a portion of the pleat profile.
32. The reusable frame of embodiment 24, wherein
   the first holder comprises a pair of first clamps, each first clamp has an engaging surface with a shape generally matching the pleat profile along the first pleated edge and are complimentarily engageable with each other; and
   the second holder comprises a pair of second clamps, each second clamp has an engaging surface with a shape generally matching the pleat profile along the second pleated edge and are complimentarily engageable with each other,
   such that at least a portion of filter along the first pleated edge and the second pleated edge are clipped between the first and the second clamps when the system is in the assembled state.
33. The reusable frame of embodiment 24, wherein
   the first holder comprises a first plate and a plurality of spaced first teeth extending perpendicularly from a longitudinal side of the first plate; and/or
      the second holder comprises a second plate and a plurality of spaced second teeth extending perpendicularly from a longitudinal side the second plate,
      wherein a spacing between two adjacent first and/or second teeth is configured to match with the respective pleat width and the teeth height is configured to match with respective pleat height such as to maintain a spaced pleat profile along the first side and/or the second side.
34. The reusable frame of any one of the embodiments 28-31, wherein the pleat spacer comprises a spacer plate and a plurality of spaced spacer teeth extending perpendicularly from a longitudinal side the spacer plate, wherein a spacing between two adjacent spacer teeth is configured to match with the respective pleat width and the teeth height is configured to match with respective pleat height.
35. The reusable frame of any one of the embodiments 28-31, wherein the at least one pleat spacer is configured to be connectable with the third holder and the fourth holder.
36. The reusable frame of any one of the embodiments 24-35, wherein the reusable frame further comprises a plurality of connectors, each connector is configured to be reversibly connecting two ends of any two of the first, second, third and fourth holders together.
37. The reusable frame of any one of the preceding embodiments, further comprising at least one supporting piece connecting to the frame.
38. The reusable frame of embodiment 37, wherein the at least one supporting piece is configured to connect between the third holder and the fourth holder.
39. The reusable frame of embodiments 37 or 38, wherein the at least one supporting piece is a rigid rib having a rectangular, trapezoid or trough cross-section.
40. The reusable filter system of any one of the embodiments 37-39, wherein the at least one supporting piece is one or more pairs of cross pieces pivotally connected with each other in one direction, each pair of the cross pieces are pivotally connected at a central coupling point, wherein the one or more pairs of cross pieces are configured to connect the third and the fourth holders so that the third and the fourth holders can be switched between a assembling position and a dissembling position from each other.
41. A method of assembling a reusable filter system for an interchangeable pleated filter, comprising the steps of:
   (a) providing the reusable filter system comprising a reusable frame, at least one flexible sheet and at least one spline as described in any one of the embodiments 1-23;
   (b) assembling the reusable frame partially or entirely by connecting first, second, third and/or fourth holders together and attaching the at least one flexible sheet to the interchangeable pleated filter;
   I installing the interchangeable pleated filter to the reusable frame;
   (d) assembling the reusable frame entirely if the same is partially assembled; aI(e) installing the at least one spline into spline receiving portion of the reusable frame.
42. The method of embodiment 41, comprising the steps of: installing at least one pleat spacer to the reusable frame.
43. The method of embodiment 41, wherein the step (b) further comprising: connecting the first, second, third and fourth holders by a plurality of connectors.
44. The method of embodiment 41, comprising the steps of: installing at least one supporting piece to the reusable frame.
45. A method of transporting the reusable filter system, comprising the steps of:
   (a) providing the reusable filter system of as described in any one of the embodiments 1-23 in an disassembled state;
   (b) packaging an interchangeable pleated filter in a collapsed state and/or the first, second, third and fourth holders in a dissembled state into either one combined or separate packaging containers to form at least one finished packaging, such that volume of space of the finished packaging is significantly redId;
   (c) delivering the finished packaging to a location for use; and
   (d) assembling the interchangeable filter and the reusable filter system for use.
46. A use of the reusable filter system of any one of the preceding embodiments in an air filtration system.
47. The use of embodiment 46, wherein the air filtration system is one or more systems selected from the group consisting of Heating, Ventilation, and Air Conditioning (HVAC), Air Conditioning and Mechanical Ventilation (ACMV), central mechanical ventilation and air conditioning (central MVAC), Variable Refrigerant Volume (VRV) or split, Air Handling Unit (AHU), Makeup Air Unit (MAU), Primary Air Unit (PAU), and Fan Coil Unit (FCU).
48. A method of air filtration using the reusable filter system of any one of the preceding embodiments, comprising the step of applying the reusable filter system to an air filtration system.
49. The method of embodiment 48, wherein the air filtration system is one or more systems selected from the group consisting of Heating, Ventilation, and Air Conditioning (HVAC), Air Conditioning and Mechanical Ventilation (ACMV), central mechanical ventilation and air conditioning (central MVAC), Variable Refrigerant Volume (VRV) or split, Air Handling Unit (AHU), Makeup Air Unit (MAU), Primary Air Unit (PAU), and Fan Coil Unit (FCU).
Set 3
1. A reusable filter system, comprising:
   (a) an interchangeable filter having a plurality of pleats, each pleat having a pleat height, a pleat width and a cross-section defining a pleat profile, the filter having a first pleated edge generally perpendicular to a direction of pleating and an opposing, second pleated edge, a first side generally parallel to the direction of pleating and an opposing, second side, and an upper pleat tip face and an opposing, lower pleat tip face; and
   (b) a reusable frame, comprising:
      (i) a first holder sized and shaped to hold the plurality of pleats along the first pleated edge;
      (ii) a second holder sized and shaped to hold the plurality of pleats along the second pleated edge;
      (iii) a third holder sized and shaped to hold the plurality of pleats along the first side; and
      (iv) a fourth holder sized and shaped to hold the plurality of pleats along the second side;
      (v) at least one pleat spacer connectable with the frame,
   wherein the first, second, third and fourth holders are configured to be reversibly connected with each other to form the reusable frame having a cavity therein to receive the filter when the system is in an assembled state, and
   wherein each of the at least one pleat spacer comprising a plurality of spacer elements being sized and shaped to match with the plurality of pleats such as to maintain a spaced, pleat profile of the filter when the system is in the assembled state.
2. The reusable filter system of embodiment 1, wherein the number of the spacer element generally match with the number of pleats, and each spacer element has a spacer element width that generally matches with the pleat width.
3. The reusable filter system of embodiment 1 or 2, wherein the at least one pleat spacer is provided in form of a spring connectable with the third holder and the fourth holder and the plurality of spacer elements are provided in form of a plurality of coils, each sized and shaped to match with the pleat width.
4. The reusable filter system of embodiment 1 or 2, wherein the at least one pleat spacer is provided in form of a zig-zag shaped that piece generally follows at least a portion of the pleat profile.
5. The reusable filter system of embodiment 1, wherein the first holder comprises a pair of first clamps, each first clamp has an engaging surface with a shape generally matching the pleat profile along the first pleated edge and are complimentarily engageable with each other; and
   the second holder comprises a pair of second clamps, each second clamp has an engaging surface with a shape generally matching the pleat profile along the second pleated edge and are complimentarily engageable with each other,
   such that at least a portion of filter along the first pleated edge and the second pleated edge are clipped between the first and the second clamps when the system is in the assembled state.
6. The reusable filter system of embodiment 1, wherein
   the first holder comprises a first plate and a plurality of spaced first teeth extending perpendicularly from a longitudinal side of the first plate; and/or
      the second holder comprises a second plate and a plurality of spaced second teeth extending perpendicularly from a longitudinal side the second plate,
      wherein a spacing between two adjacent first and/or second teeth is configured to match with the respective pleat width and the teeth height is configured to match with respective pleat height such as to maintain a spaced pleat profile along the first side and/or the second side.
7. The reusable filter system of embodiment 1 or 2, wherein the pleat spacer comprises a spacer plate and a plurality of spaced spacer teeth extending perpendicularly from a longitudinal side the spacer plate, wherein a spacing between two adjacent spacer teeth is configured to match with the respective pleat width and the teeth height is configured to match with respective pleat height.
8. The reusable filter system of any one of the preceding embodiments, wherein the at least one pleat spacer is configured to be connectable with the third holder and the fourth holder.
9. The reusable filter system of any one of the preceding embodiments, wherein the system further comprises:
   at least one flexible sheet, configured to attach to at least a portion of the upper pleat tip face and/or lower pleat tip face and to extend outward from the first pleated edge and the second pleated edge to form a first pleated edge extension and a second pleated edge extension, respectively; and
   at least one spline,
   wherein each of the first, second, third and fourth holders further comprises a spline receiving portion sized and shaped to receive the spline, such that the spline receiving portion of each of the first, second, third and fourth holders can frictionally retain the first pleated edge extension, the second pleated edge extension, the first side and the second side therein respectively, when the at least one spline is installed into the spline receiving portion.
10. The reusable filter system of embodiment 9, wherein the at least one flexible sheet is at least partially air permeable.
11. The reusable filter system of embodiment 9 or 10, wherein the at least one flexible sheet is fixedly attached to the filter by adhesive, thermal bonding and/or ultrasonic welding.
12. The reusable filter system of embodiment 9 or 10, wherein the at least one flexible sheet is a continuous sheet sized and shaped sufficient to cover entire upper pleat tip face or entire lower pleat tip face and to extend outwardly from the first pleated edge and the second pleated edge.
13. The reusable filter system of any one of the preceding embodiments, wherein the at least one flexible sheet comprises a first flexible sheet and a second flexible sheet, the first flexible sheet is sized and shaped sufficient to cover entire upper pleat tip face or entire lower pleat tip face and to extend outwardly from the first pleated edge, and the second flexible sheet is sized and shaped sufficient to cover entire upper pleat tip face or entire lower pleat tip face and to extend outwardly from the second pleated edge.
14. The reusable filter system of any one of the preceding embodiments, wherein all the spline receiving portions together form a continuous spline channel for receiving a spline, when the system is in the assembled state.
15. The reusable filter system of any one of the preceding embodiments, wherein each spline receiving portion further comprises at least one ridge to frictionally limit the spline therein.
16. The reusable filter system of any one of the preceding embodiments, wherein the spline further comprises a spline flap piece extended along a longitudinal length of the spline to limit the first pleated edge, the second pleated edge, the first side and/or the second side within the frame, when the system is in the assembled state.
17. The reusable filter system of embodiment 18, wherein the spline further comprising a neck portion connecting the spline and the spline flap piece.
18. The reusable filter system of embodiment 19, wherein the neck portion further comprises at least one dent, and the spline receiving portion further comprising at least one ridge sized and shaped to mate with the corresponding dent to secure the spline in the spline receiving portion.
19. The reusable filter system of any one of the preceding embodiments, wherein the reusable frame further comprises a plurality of connectors, each connector is configured to be reversibly connecting two ends of any two of the first, second, third and fourth holders together.
20. The reusable filter system of any one of the preceding embodiments, further comprising at least one supporting piece connecting to the reusable frame.
21. The reusable filter system of embodiment 20, wherein the at least one supporting piece is configured to connect between the third holder and the fourth holder.
22. The reusable filter system of embodiment 20 or 21, wherein the at least one supporting piece is a rigid rod comprising a rectangular, trough or trapezoid cross-section.
23. The reusable filter system of any one of the embodiments 20-22, wherein the at least one supporting piece is one or more pairs of cross pieces pivotally connected with each other in one direction, each pair of the cross pieces are pivotally connected at a central coupling point, wherein the one or more pairs of cross pieces are configured to connect the third and the fourth holders so that the third and the fourth holders can be switched between an assembling position and a dissembling position.
24. A reusable frame for an interchangeable pleated filter, the filter having a plurality of pleats, each pleat having a pleat height, a pleat width and a cross-section defining a pleat profile, the filter having a first pleated edge generally perpendicular to a direction of pleating and an opposing, second pleated edge, a first side generally parallel to the direction of pleating and an opposing, second side, and an upper pleat tip face and an opposing, lower pleat tip face, the filter further comprising at least one flexible sheet, configured to attach to at least a portion of the upper pleat tip face and/or lower pleat tip face and to extend outward from the first pleated edge and the second pleated edge to form a first pleated edge extension and a second pleated edge extension, respectively, the reusable frame comprising:
   (i) a first holder sized and shaped to hold the plurality of pleats along the first pleated edge;
   (ii) a second holder sized and shaped to hold the plurality of pleats along the second pleated edge;
   (iii) a third holder sized and shaped to hold the plurality of pleats along the first side;
   (iv) a fourth holder sized and shaped to hold the plurality of pleats along the second side; and
   (v) at least one pleat spacer connectable with the frame, wherein the first, second, third and fourth holders are configured to be reversibly connected with each other to form the reusable frame having a cavity therein to receive the filter when the system is in the assembled state, and
   wherein each of the at least one pleat spacer comprising a plurality of spacer elements being sized and shaped to match with the plurality of pleats such as to maintain a spaced, pleat profile of the filter when the system is in the assembled state.
25. The reusable frame of embodiment 24, wherein each of the first, second, third and fourth holders further comprises a spline receiving portion sized and shaped to receive a spline, such that the spline receiving portion of each of the first, second, third and fourth holders can frictionally retain the first pleated edge extension, the second pleated edge extension, the first side and the second side therein respectively, when the at least one spline is installed into the spline receiving portion;
wherein all the spline receiving portions together form a continuous channel for receiving the spline, when the system is in the assembled state.
26. The reusable frame of embodiment 24 or 25, wherein each spline receiving portion further comprises at least one ridge to frictionally limit the spline therein.
27. The reusable frame of any one of the embodiments 24-26, wherein the spline receiving portion further comprising at least one ridge sized and shaped to mate with the corresponding dent to secure the spline in the spline receiving portion.
28. The reusable frame of embodiment 24, wherein number of the spacer element generally match with the number of pleats, and each spacer element has a spacer element width that generally matches with the pleat width.
29. The reusable frame of embodiment 24, wherein the at least one pleat spacer is provided in form of a spring connectable with the third holder and the fourth holder and the plurality of spacer elements are provided in form of a plurality of coils, each sized and shaped to match with the pleat width.
30. The reusable frame of embodiment 24, wherein the at least one pleat spacer is provided in form of a zig-zag shaped piece that generally follows at least a portion of the pleat profile.
31. The reusable frame of embodiment 24, wherein
   the first holder comprises a pair of first clamps, each first clamp has an engaging surface with a shape generally matching the pleat profile along the first pleated edge and are complimentarily engageable with each other; and
   the second holder comprises a pair of second clamps, each second clamp has an engaging surface with a shape generally matching the pleat profile along the second pleated edge and are complimentarily engageable with each other,
   such that at least a portion of filter along the first pleated edge and the second pleated edge are clipped between the first and the second clamps when the system is in the assembled state.
32. The reusable frame of embodiment 24, wherein
   the first holder comprises a first plate and a plurality of spaced first teeth extending perpendicularly from a longitudinal side of the first plate; and/or
      the second holder comprises a second plate and a plurality of spaced second teeth extending perpendicularly from a longitudinal side the second plate,
      wherein a spacing between two adjacent first and/or second teeth is configured to match with the respective pleat width and the teeth height is configured to match with respective pleat height such as to maintain a spaced pleat profile along the first side and/or the second side.
33. The reusable frame of any one of the embodiments 24-32, wherein the pleat spacer comprises a spacer plate and a plurality of spaced spacer teeth extending perpendicularly from a longitudinal side the spacer plate, wherein a spacing between two adjacent spacer teeth is configured to match with the respective pleat width and the teeth height is configured to match with respective pleat height.
34. The reusable frame of any one of the embodiments 24-33, wherein the at least one pleat spacer is configured to be connectable with the third holder and the fourth holder.
35. The reusable frame of any one of the embodiments 24-34, wherein the reusable frame further comprises a plurality of connectors, each connector is configured to be reversibly connecting two ends of any two of the first, second, third and fourth holders together.
36. The reusable frame of any one of the preceding embodiments, further comprising at least one supporting piece connecting to the frame.
37. The reusable frame of embodiment 36, wherein the at least one supporting piece is configured to connect between the third holder and the fourth holder.
38. The reusable frame of embodiments 36 or 37, wherein the at least one supporting piece is a rigid rod comprising a rectangular, trough or trapezoid cross-section.
39. The reusable filter system of any one of the embodiments 36-38, wherein the at least one supporting piece is one or more pairs of cross pieces pivotally connected with each other in one direction, each pair of the cross pieces are pivotally connected at a central coupling point, wherein the one or more pairs of cross pieces are configured to connect the third and the fourth holders so that the third and the fourth holders can be switched between a spaced position and a proximate position from each other.
40. A method of assembling a reusable filter system for an interchangeable pleated filter, comprising the steps of:
   (a) providing the reusable filter system comprising a reusable frame, as described in any one of the embodiments 1-23;
   (b) assembling the reusable frame partially or entirely by connecting first, second, third and fourth holders together and installing at least one pleat spacer to the reusable frame;
   (c) installing the interchangeable pleated filter to the reusable frame; and
   (d) assembling the reusable frame entirely if the same is partially assembled.
41. The method of embodiment 40, comprising the steps of:
installing at least one spline to spline receiving portion of the reusable frame and/or attaching at least one flexible sheet to the interchangeable pleated filter.
42. The method of embodiment 40, wherein the step (b) further comprising:
connecting the first, second, third and fourth holders by a plurality of connectors.
43. The method of embodiment 40, comprising the steps of:
installing at least one supporting piece to the reusable frame.
44. A method of transporting the reusable filter system, comprising the steps of:
   (a) providing the reusable filter system of as described in any one of the embodiments 1-23 in an disassembled state;
   (b) packaging the interchangeable pleated filter in a collapsed state and/or the reusable filter system in a dissembled state into one or more packaging containers to form at least one finished packaging, such that volume of space of the finished packaging is significantly reduced;
   (c) delivering the finished packaging to a location for use; and
   (d) assembling the reusable filter system for use.
45. A use of the reusable filter system of any one of the preceding embodiments in an air filtration system.
46. The use of embodiment 45, wherein the air filtration system is one or more systems selected from the group consisting of Heating, Ventilation, and Air Conditioning (HVAC), Air Conditioning and Mechanical Ventilation (ACMV), central mechanical ventilation and air conditioning (central MVAC), Variable Refrigerant Volume (VRV) or split, Air Handling Unit (AHU), Makeup Air Unit (MAU), Primary Air Unit (PAU), and Fan Coil Unit (FCU).
47. A method of air filtration using the reusable filter system of any one of the preceding embodiments, comprising the step of applying the reusable filter system to an air filtration system.
48. The method of embodiment 47, wherein the air filtration system is one or more systems selected from the group consisting of Heating, Ventilation, and Air Conditioning (HVAC), Air Conditioning and Mechanical Ventilation (ACMV), central mechanical ventilation and air conditioning (central MVAC), Variable Refrigerant Volume (VRV) or split, Air Handling Unit (AHU), Makeup Air Unit (MAU), Primary Air Unit (PAU), and Fan Coil Unit (FCU).

### EXAMPLES

Provided herein are examples that describe in more detail certain embodiments of the present disclosure. The examples provided herein are merely for illustrative purposes and are not meant to limit the scope of the invention in any way. All references given below and elsewhere in the present application are hereby included by reference.

For ease of description, all subsequent drawings with the same reference numeral refer to the same part, and will not be repeated in the description of each drawing.

### Example Embodiment 1: Reusable Filter Frame and System 1000

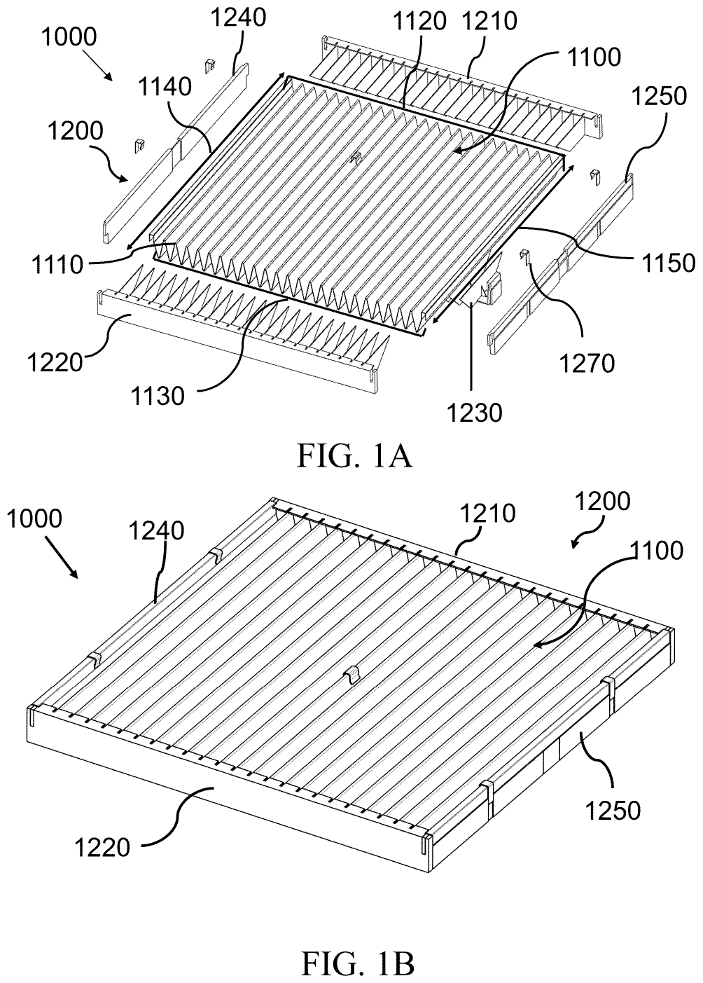

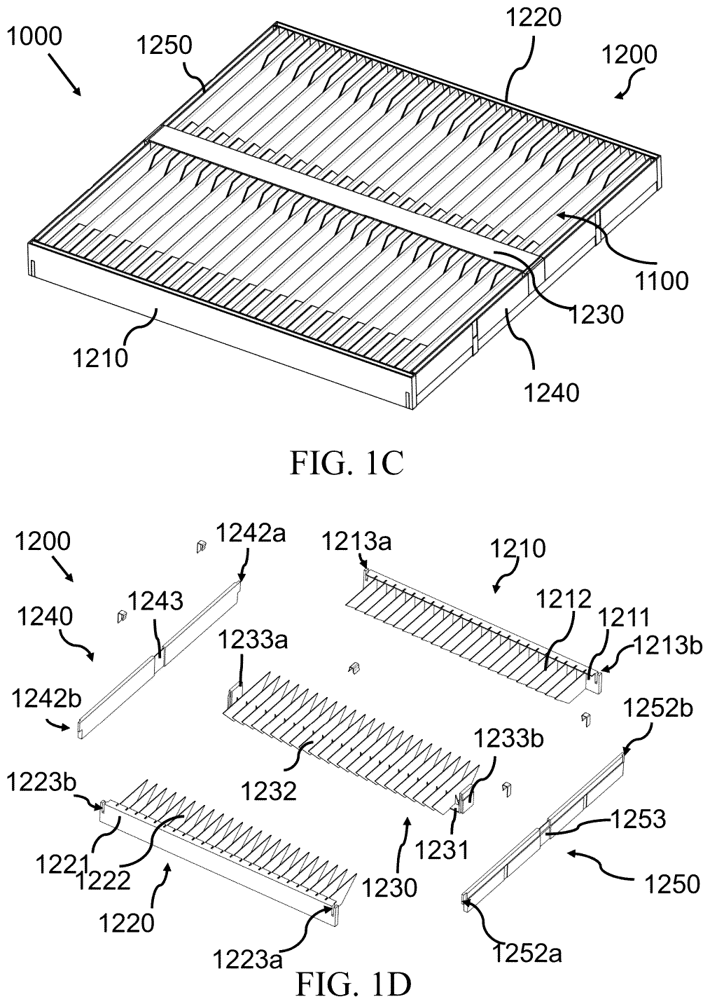

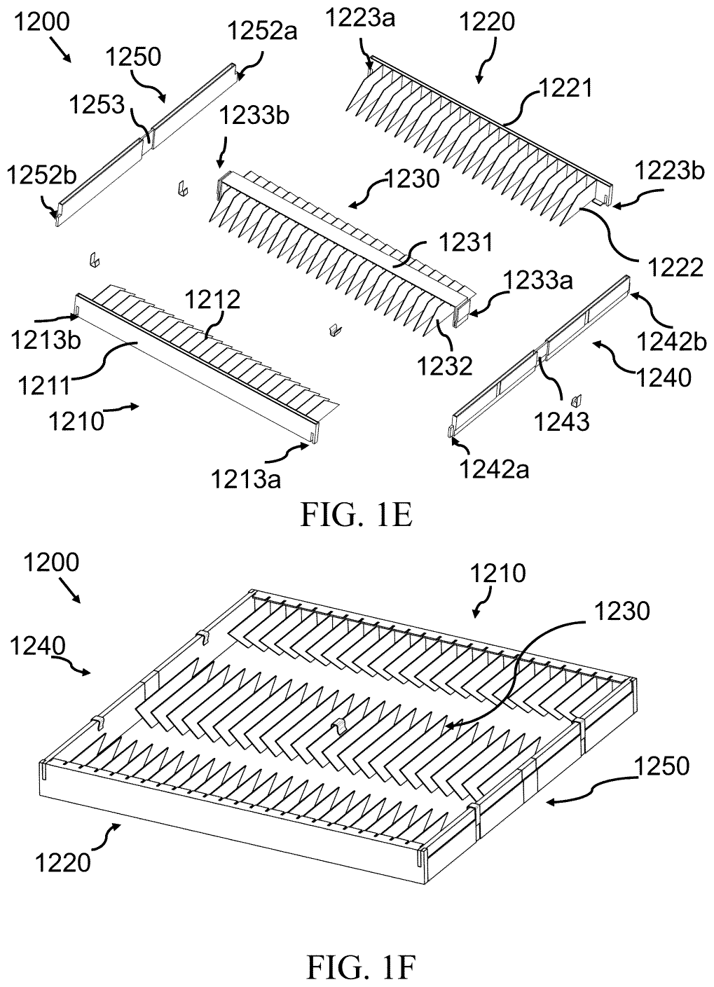

FIG. 1A shows a perspective exploded view of an example reusable filter system 1000. The filter system 1000 includes an interchangeable filter material 1100 and a reusable frame 1200. The filter 1100 includes a plurality of (e.g., twenty-three) longitudinally extending pleats 1110. Each pleat has a pleat height, a pleat width and a cross-section defining a pleat profile when it is expanded in an assembled state. The filter 1100 has a first pleated edge 1120 generally perpendicular to a direction of pleating and an opposing, second pleated edge 1130, and a first side 1140 generally parallel to the direction of pleating and an opposing, second side 1150. As an example, the filter 1100 may be a HEPA filter. As an example, the filter 1100 may be made of woven and/or non-woven filter material(s). As an example, the pleat profile may be a continuous or discrete rectangle, triangle, trapezoid and/or oval shape.

Still referring to FIG. 1A, the reusable frame 1200 includes a first holder 1210, a second holder 1220, a third holder 1230 (partially shown), a first linker 1240, and a second linker 1250. The first and second holders 1210, 1220 are sized and shaped to cover and support each of the plurality of pleats of the filter 1100 along the first pleated edge 1120 and the second pleated edge 1130, respectively. The first and second linkers 1240, 1250 are reversibly connectable with the first and second holders 1210, 1220 along the first and second sides 1140, 1150, respectively. The holders and linkers will be more clearly shown in FIG. 1D-1F and described in more detail. Optionally, the frame 1200 may further includes a plurality of (e.g., five) clips 1270. As an example, the frame may be made of fire resistant materials (e.g., metals such as aluminum or plastics such as PP).

FIGS. 1B-1C show perspective views of the same filter system 1000 in an assembled state. The first, second holders 1210, 1220 and the third holder 1230 and the first and second linkers 1240 and 1250 together form a rectangular shaped frame 1200 and a cavity therein to fittingly receive the filter 1100, providing a strong mechanical protection to the filter 1100 and maintaining the pleated structure or geometry of the filter media.

Now referring to FIG. 1D-1F, the frame 1200 is shown and described in more detail. FIGS. 1D-1E show two opposite perspective exploded views of an example reusable frame 1200 (without filter material) in a dissembled state. The first holder 1210 includes an elongated first plate 1211 and a plurality of spaced first teeth 1212 extending perpendicularly from a longitudinal side of the first plate 1211, each of the first teeth 1212 has a longitudinal section with a shape of right-angled trapezoid. The first plate 1211 further includes a flap extended along the top, longitudinal side of the first plate 1211. This flap can help holding on the filter within the frame 1200 when filter is installed, even if the frame 1200 is placed upside-down. Similarly, the second holder 1220 includes a second plate 1221 and a plurality of spaced second teeth 1222 extending perpendicularly from a longitudinal of side the second plate 1221, each of the second teeth 1222 has a shape of right-angled trapezoid in a longitudinal section. The second plate 1221 further includes a flap extended along the top, longitudinal side of the second plate 1221. This flap can help holding on the filter within the frame 1200 when filter is installed, even if the frame 1200 is placed upside-down. The spacing between two adjacent teeth generally matches with the respective pleat width of the filter. The teeth height generally matches with respective pleat height. As such, the frame is adapted for use with various filter materials having similar pleat height and pleat width but having different pleating profiles or geometries, making the system becomes a universal fit for filters with different pleat profiles. Slots 1213a,b and 1223a,b are disposed proximate to each of the longitudinal ends of the first and the second holders, respectively. Protrusions 1242a,b and 1252a,b are disposed at each of the longitudinal ends of the first and the second linkers 1240 and 1250, respectively. These slots 1213a,b and 1223a,b and protrusions 1242a,b and 1252a,b are configured such that they can be reversibly, fittingly engaged together to form a rectangular frame. The third holder 1230 is positioned in a middle position traverse and below the filter, with the longitudinal side generally perpendicular to the direction of pleating. The third holder 1230 is sized and shaped to support the plurality of pleats along the middle position. The third holder 1230 includes an elongated third plate 1231 and a plurality of spaced third teeth 1232 extending perpendicularly from a longitudinal side the third plate, each of the third teeth 1232 has a longitudinal section with a shape of a symmetrical trapezoid. The spacing between two adjacent third teeth 1232 is configured to match with the respective pleat width and the teeth height is configured to match with respective pleat height of the filter. Third clasp portions 1233a,b are disposed at each of the longitudinal ends of the third holder, respectively. Indent portions 1243 and 1253 are disposed in the middle of the longitudinal side of the first and the second linkers 1240 and 1250, respectively. These third clasp portions 1233a,b and indent portions 1243 and 1253 are configured such that they can be reversibly, fittingly engaged together to strengthen the mechanical support of the frame in the middle position.

FIG. 1F shows a perspective view of the same filter frame 1200 in an assembled state. The holders 1210, 1220 and 1230 and linkers 1240 and 1250 together form a rectangular shaped frame 1200 when it is in an assembled state.

### Example Embodiment 2: Reusable Filter System 2000

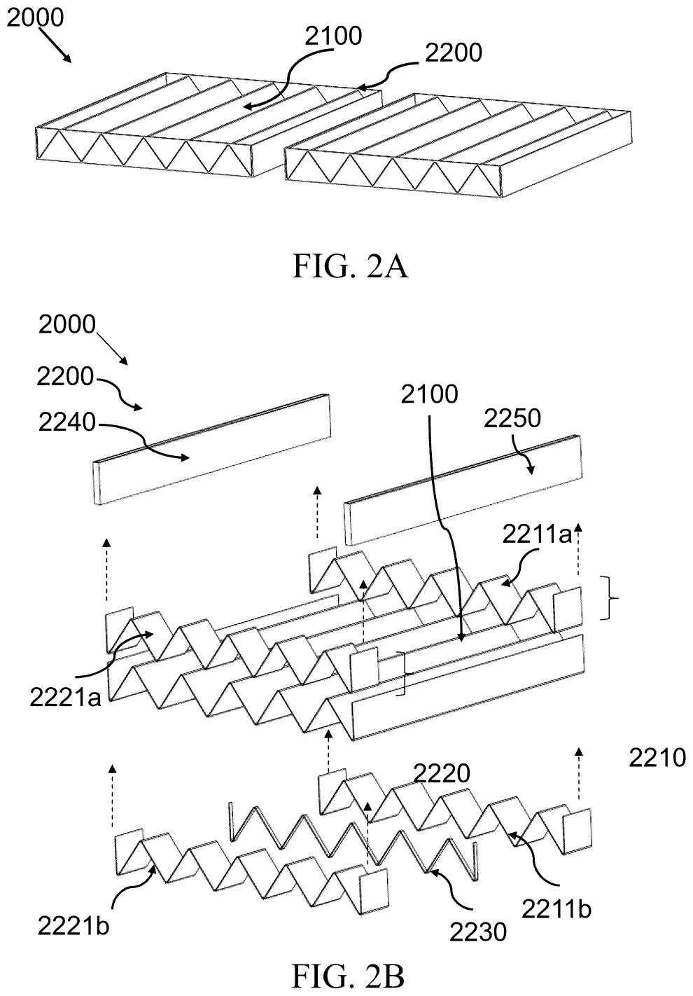

FIG. 2A shows perspective views of another example reusable filter system 2000 in an assembled state. The filter system 2000 includes an interchangeable filter material 2100 and a reusable frame 2200.

FIG. 2B shows an exploded view of the system 2000 containing a filter 2100 having a triangular pleat profile and a reusable frame 2200 includes a first holder 2210, a second holder 2220, a third holder 2230, a first linker 2240, and a second linker 2250. The first holder 2210 includes an upper first clamp 2211a and lower first clamp 2211b, and the second holder 2220 includes an upper second clamp 2221a and lower second clamp 2221b. Each pair of clamps 2211a,b and 2221a,b are shaped complementarily to each other. The holders 2210, 2220 and 2230 have zig-zag shaped filter facing surface(s). The clamps 2211a,b and 2221a,b have generally the same profile in their engaging surfaces as the pleat profile of the filter 2100, so that the filter 2100 can be fixed between the holders, securing a uniformly spaced, pleated structure of the filter 2100 when the system 2000 is in an assembled state. The first and second holders 2210 and 2220 further include vertical extensions at each longitudinal ends shaped to slot into the first and second linkers 2240 and 2250, respectively, at positions as indicated in the arrows.

### Example Embodiment 3: Preparation and Assembling the Filter System

In an example embodiment, provided is a method of preparing a filter system, comprising the steps of:
(a) providing a filter material comprising a plurality of pleats, each pleat having a pleat height, a pleat width and a cross-section defining a pleat profile, the filter having a first pleated edge generally perpendicular to a direction of pleating and an opposing, second pleated edge defining a variable filter width, and a first side generally parallel to the direction of pleating and an opposing, second side defining a filter length;
(b) providing a reusable frame, the frame comprising a first holder sized and shaped to cover and support each of the plurality of pleats along the first pleated edge; a second holder sized and shaped to cover and support each of the plurality of pleats along the second pleated edge; a first linker connectable with the first and second holders along the first side; and a second linker connectable with the first and second holders along the second side;
(c) when the system is in an disassembled state, packaging the filter in a collapsed form and the holders and frames in a compact (e.g., staggered or stacking) arrangement, and
when the system is in assembled state, assembling the filter and the frame forming from the holders and linkers, such that the first and the second holders interact with the plurality of pleats to enclose the filter and secure a spaced, pleated structure of the filter.

### Example Embodiment 4: Methods of Packaging for Transportation

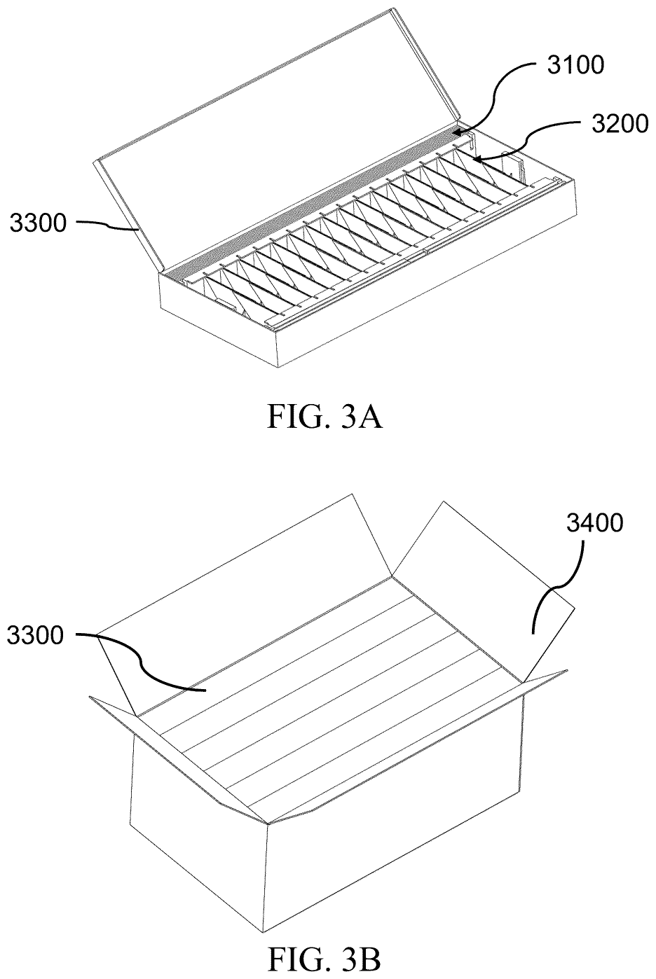

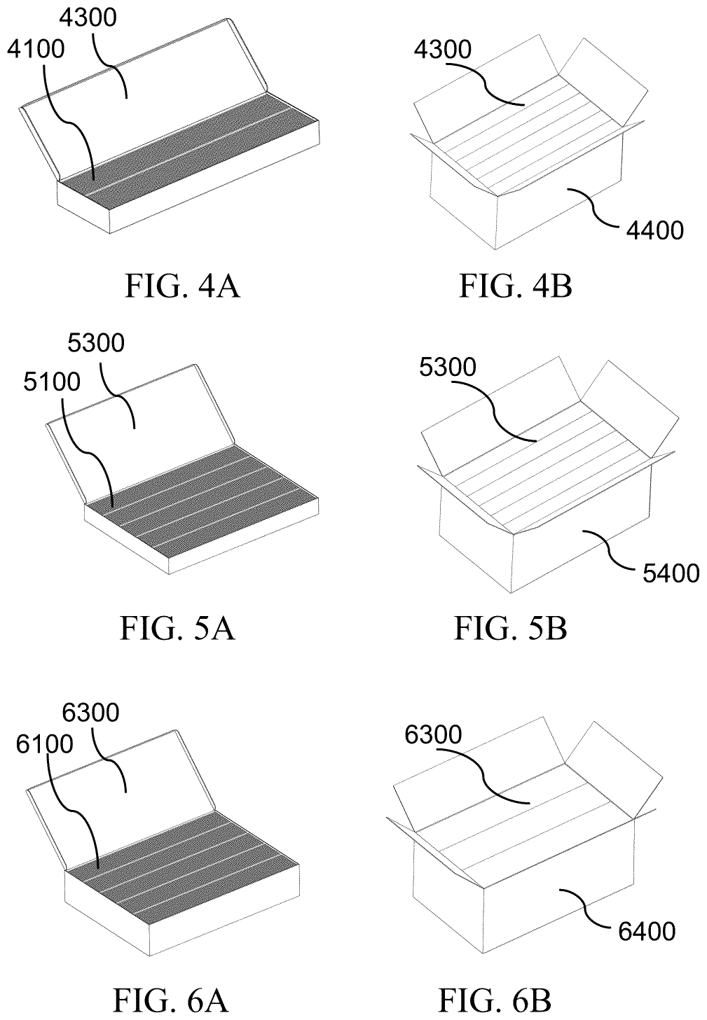

In one example, embodiment, provided is a method of transporting the filter system, comprising the steps of:
(a) providing the filter system as described herein in an disassembled state.
(b) packaging the filter in a collapsed form and/or the holders and linkers in compact (e.g., staggered or stacking) arrangement into either one combined or separate packaging containers to form a finished packaging(s), such that volume of space in the finished packaging is significantly reduced. By way of example, the collapsed filter 3100 and the frame 3200 (holders and linkers) in disassembled state may be packaged together in one K3K pack 3300, as shown in FIG. 3A, and then six of these K3K packs 3300 can be further packaged into one A3A box 3400, as shown in FIG. 3B. By way of example, the filter and the frame (holders and linkers) may be packaged separately. By way of example, two collapsed filters 4100 may be packaged in one K3K pack 4300, as shown in FIG. 4A, and then six of these K3K packs 4300 can be further packaged into one A3A box 4400, as shown in FIG. 4B. By way of example, five collapsed filters 5100 may be packaged in one K3K pack 5300, as shown in FIG. 5A, and then six of these K3K packs 5300 can be further packaged into one A3A box 5400, as shown in FIG. 5B. By way of example, ten collapsed filters may be packaged in one K3K pack 6300 in two layers (each layer has five filters 6100), as shown in FIG. 6A, and then three of these K3K packs 6300 can be further packaged into one A3A box 6400, as shown in FIG. 6B.
(c) delivering the finished packaging(s) to a location for use.
(d) assembling the filter and the frame into filter system for use. By way of example, a used filter system may be dissembled and the used filter may be disposed. The frame may be reused with a new filter.

### Example Embodiment 5: Methods of Assembling a Filter System

To assemble a reusable filter system, the following steps are involved:
(i) providing the filter system as described herein in an dissembled state.
(ii) connecting the first holder with the first and second linkers to form an open ended, partial frame.
(iii) optionally, connecting the third holder with the first and second linkers.
(iv) installing interchangeable filter to the partial frame.
(v) connecting the second holder to the partial frame.
(vi) optionally, clasping at least a portion of the filter onto the frame by a plurality of clips.

The first and the second linkers are connected with the third holder to form a frame with a cavity therein to accommodate the filter, and the first and the second holders interact with the plurality of pleats to secure a spaced, pleated structure of the filter when the system is in assembled state, such that each of the first and the second linkers is connected with the first and the second holders to form a frame with a cavity therein to accommodate the filter, and the first and the second holders interact with the plurality of pleats to secure a spaced, pleated structure of the filter when the system is in assembled state.

In the following examples, the first and second linkers described in the previous example embodiments 1-5 are called third and fourth holders, respectively; the third holder described in the previous example embodiments 1-5 is called supporting piece and/or pleat spacer; the flap descried in the previous example embodiments 1-5 is called holder flap.

### Example Embodiment 6: Reusable Filter Frame 7200 and System 7000

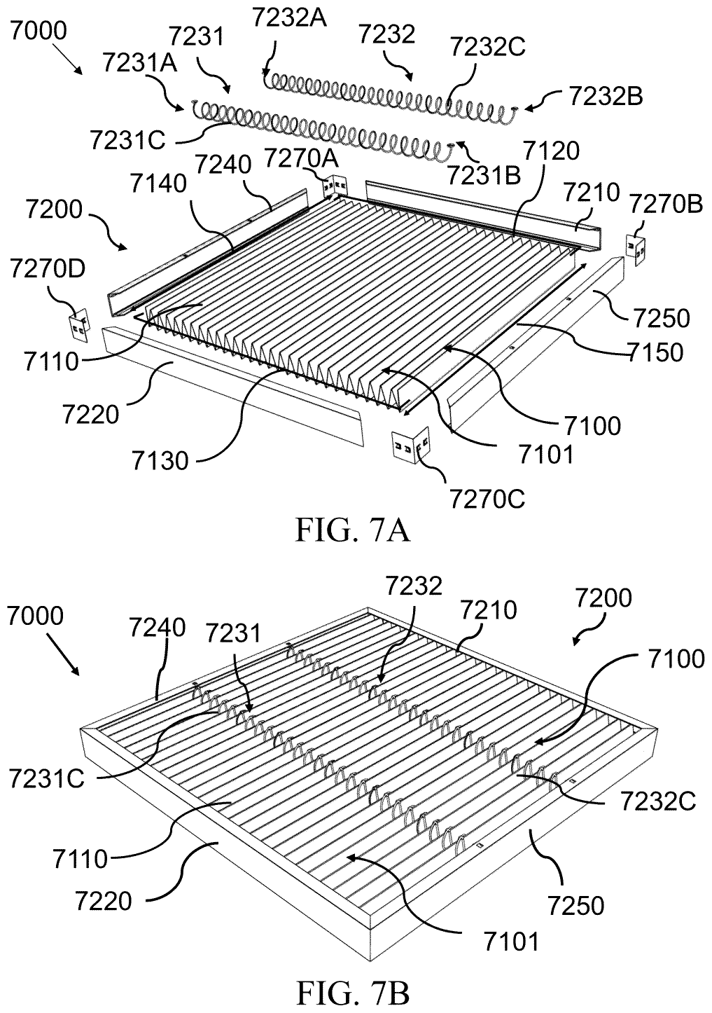

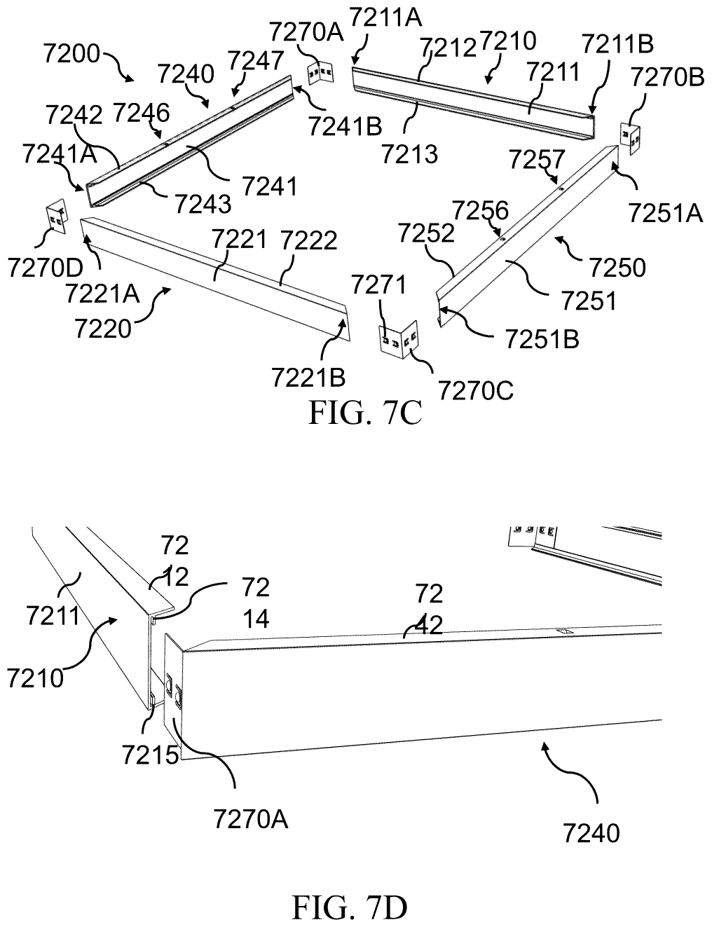

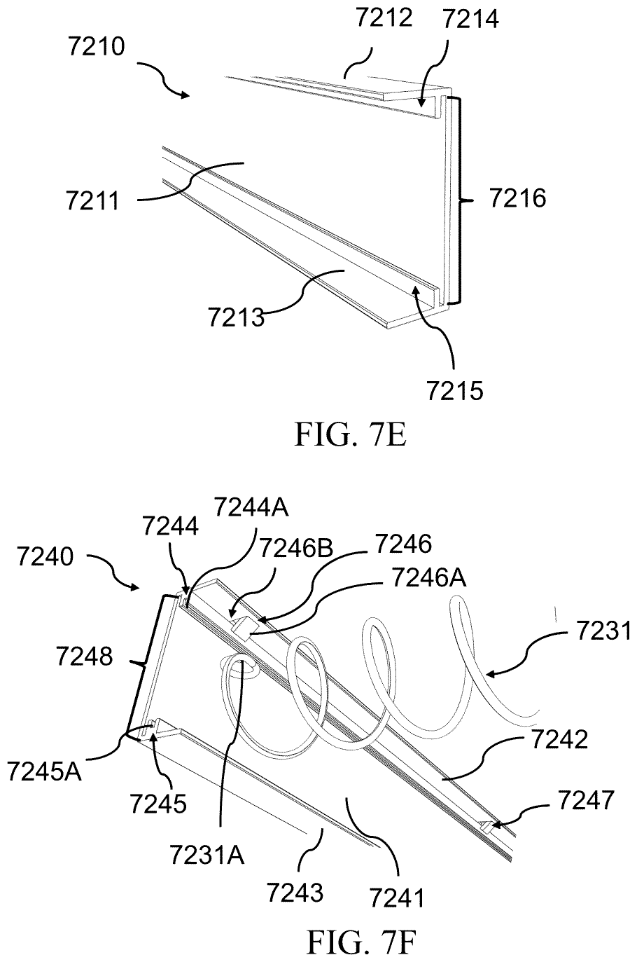

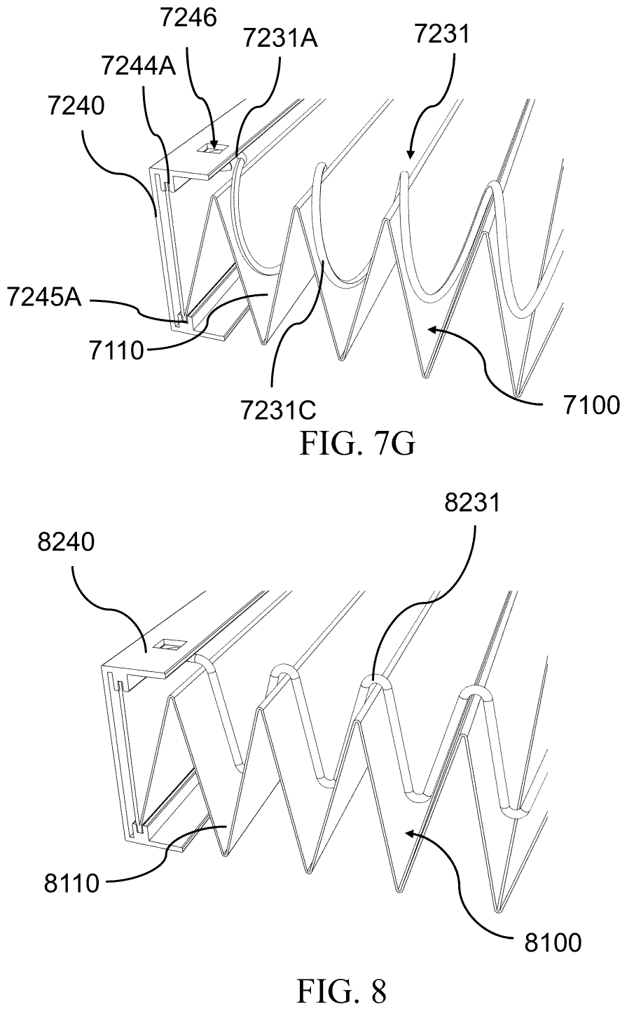

FIG. 7A-7G shows another example reusable filter system 7000 which generally includes a reusable frame 7200 and two pleat spacers 7231 and 7232. FIG. 7A is a perspective exploded view of the example reusable filter system 7000. The filter system 7000 includes a reusable frame 7200 which holds the interchangeable filter material 7100. The filter 7100 includes a plurality of longitudinally extending, generally equally spaced multiple pleats 7110. Each pleat has a pleat height, a pleat width and a cross-section defining a pleat profile when it is expanded in an assembled state. The filter 7100 has a first pleated edge 7120 generally perpendicular to a direction of pleating and an opposing, second pleated edge 7130, a first side 7140 generally parallel to the direction of pleating and an opposing, second side 7150, and an upper pleated face 7101 and an opposing, lower pleated face (not shown). For ease of description, the direction towards the upper pleated face 7101 is called up, and the direction towards the lower pleated face is called down (or low). In this example, the plurality of pleat profile has a continuous V-shaped (or zig-zag shaped) cross-section, and the filter generally has even pleat width and pleat height. In certain examples, the filter 7100 can be made of woven and/or non-woven filter material(s). In certain examples, the filter 7100 is reusable (e.g., after cleaning and/or disinfection), or disposable. In one example, the filter is a HEPA filter.

Still referring to FIG. 7A, the reusable frame 7200 includes a first holder 7210, a second holder 7220, a third holder 7240, and a fourth holder 7250. The first and second holders 7210, 7220 are sized and shaped to cover and support the plurality of pleats of the filter 7100 along the first pleated edge 7120 and the second pleated edge 7130, respectively. The third and fourth holders 7240, 7250 are sized and shaped to cover and support the filter 7100 along the first and second sides 7140, 7150, respectively. In this embodiment, the frame 7200 further includes four frame connectors 7270A-7270D adapted to reversibly connect two longitudinal ends of any two of the first holder 7210, the second holder 7220, the third holder 7240, and the fourth holder 7250 with each other. The structures and connections of the holders and the frame connectors will be more clearly shown in FIG. 7C-7E and described in more detail. The holders can be made of hard materials such as metals (e.g., aluminum), alloys such as steel, plastic such as PC, ABS, PVC, elastomers such as EPDM, or Silicone rubber.

The filter system 7000 further comprises two pleat spacers 7231 and 7232 connectable with the reusable frame 7200. Each of the two pleat spacers 7231 and 7232 has a plurality of spacer elements being sized and shaped to match with the plurality of pleats 7110 of the filter 7100. The term “match” means the number of spacer elements equals to or generally close to to number of pleats, and the width of each spacer element equals to or generally close to the pleat width, when the system is in assembled state. The profile of each spacer element may generally follows the pleat profile, but does not necessarily the same. In this embodiment, each of the pleat spacers 7231 and 7232 are provided in form of a spring connectable with the third holder 7240 and the fourth holder 7250, and the plurality of spacer elements are provided in form of a plurality of coils. Specifically, the pleat spacer 7231 is a spring with an end 7231A connectable with the third holder 7240, another opposing end 7231B connectable with the fourth holder 7250, and a plurality of coils 7231C therebetween, each sized and shaped to match with the pleat width of the filter 7100. The pleat spacer 7232 is a spring with an end 7232A connectable with the third holder 7240, another opposing end 7232B connectable with the fourth holder 7250, and a plurality of coils 7232C therebetween, each sized and shaped to match with the pleat width of the filter 7100. In some embodiments, the number of the coils 7231C and 7232C generally equals to the number of the pleats 7110 of the filter 7100 to maintain the pleated structure or geometry of the filter 7100.

FIG. 7B shows a perspective view of the same filter system 7000 in an assembled state. The first, second, third and fourth holders 7210, 7220, 7240 and 7250 are connected together via the frame connectors to form a rectangular (square) shaped frame 7200 and a cavity therein to fittingly receive the filter 7100. The pleat spacers 7231 and 7232 are both connected to the third holder 7240 and the fourth holder 7250, and extended parallel to the upper pleated face 7101 of the filter 7100 and generally perpendicular to the direction of pleating of the filter 7100. In this embodiment, each of the coils 7231C and 7232C of the respective pleat spacers 7231 and 7232 has a generally uniform coil width that generally matches the pleat width of the pleats 7110, such that each pleat 7110 can be contained within the winding of each coil, thereby acting as supporting piece to provide a strong mechanical support to the filter 7100 and at the same time maintaining a spaced, pleat profile of the filter 7100 when the system is in an assembled state. In some other embodiments, one or more pleats can be contained within the winding of each coil.

Now referring to FIG. 7C, the reusable frame 7200 is shown and described in more detail. FIG. 7C shows a perspective exploded view of an example reusable frame 7200 (without filter material and pleat spacers) in a dissembled state. The first holder 7210 includes an elongated first plate 7211 with two opposite longitudinal ends 7211A and 7211B, an upper holder flap 7212 extended along the top, longitudinal side of the first plate 7211, and a lower holder flap 7213 extended along the bottom, longitudinal side of the first plate 7211. The upper holder flap 7212 and the lower holder flap 7213 are in isosceles trapezoid shape such that the holders can be assembled to each other. These holder flaps can help holding or limiting on the filter within the frame 7200 when filter is installed, even if the frame 7200 is placed upside-down. Similarly, the second holder 7220 includes an elongated second plate 7221 with two opposite ends 7221A and 7221B, an upper holder flap 7222 extended along the top, longitudinal side of the second plate 7221, and a lower holder flap (not shown) extended along the bottom, longitudinal side of the second plate 7221; the third holder 7240 includes an elongated third plate 7241 with two opposite ends 7241A and 7241B, an upper holder flap 7242 extended along the top, longitudinal side of the third plate 7241, and a lower holder flap 7243 extended along the bottom, longitudinal side of the third plate 7241; the fourth holder 7250 includes an elongated fourth plate 7251 with two opposite ends 7251A and 7251B, an upper holder flap 7252 extended along the top, longitudinal side of the fourth plate 7251, and a lower holder flap (not shown) extended along the bottom, longitudinal side of the fourth plate 7251. In this example, the first, second, third and fourth holders 7210, 7220, 7230 and 7240 are structurally the same or very similar to each other, thus easy to manufacture. In this embodiment, the upper holder flap 7242 of the third holder 7240 includes two notches 7246 and 7247 for connecting with the pleat spacers. Similarly, the upper holder flap 7252 of the fourth holder 7250 includes two notches 7256 and 7257 at the corresponding positions for connecting with the pleat spacers. The structure of these notches will be described in detail in FIGS. 7F-7G.

In this embodiment, four L-shaped frame connectors 7270A-7270D are provided, each with two arms that are generally perpendicular with each other and configured to reversibly connect two holders at their respective ends. In this example, each arm of the frame connectors includes two knobs on both opposing surfaces, each knob surrounded by a C-shaped slit, so that the frame connectors can frictionally (and reversibly) abut against to the holder when the arm is inserted in the gap created by the ridges. In this example, the overall profile of frame connectors 7270A-7270D are the same or very similar to each other, thus easy and cheap to manufacture. For example, the frame connector 7270A is adapted to reversibly connect the end 7211A of the first holder 7210 with the end 7241B of the third holder 7240; the frame connector 7270B is adapted to connect the end 7211B of the first holder 7210 with the end 7251A of the fourth holder 7250; the frame connector 7270C is adapted to connect the end 7251B of the fourth holder 7250 with the end 7221B of the second holder 7220; and the frame connector 7270D is adapted to connect the end 7221A of the second holder 7220 with the end 7241A of the third holder 7240.

Now referring to FIG. 7D-7F. FIG. 7D illustrates the connections between the first holder 7210 and the third holder 7240 via the frame connector 7270A. Referring to FIGS. 7D and 7E, the first holder 7210 further includes an upper ridge 7214 at the inner side extending downwardly and generally perpendicularly from the upper holder flap 7212 along the length of the upper holder flap 7212, defining a gap between the upper ridge 7214 and the first plate 7211. The first holder 7210 also includes a lower ridge 7215 at the inner side extending upwardly and generally perpendicularly from the lower holder flap 7213 along the length of the lower holder flap 7213, defining a gap between the lower ridge 7215 and the first plate 7211. The width of the gap between the upper ridge 7214 and the first plate 7211 is generally the same with the width of the gap between the lower ridge 7215 and the first plate 7211, and both gaps together form an inner channel 7216 adapted to slidably receive an arm of the frame connector 7270A.

Referring now to FIGS. 7D and 7F, the third holder 7240 further includes an upper ridge 7244 extending downwardly and generally perpendicularly from the upper holder flap 7242 along the length of the upper holder flap 7242, defining a gap between the upper ridge 7244 and the third plate 7241. The third holder 7240 also includes a lower ridge 7245 extending upwardly and generally perpendicularly from the lower holder flap 7243 along the length of the lower holder flap 7243, defining a gap between the lower ridge 7244 and the third plate 7241. The width of the gap between the upper ridge 7244 and the third plate 7241 is generally the same with the width of the gap between the lower ridge 7245 and the third plate 7241, and both gaps together form an inner channel 7248 adapted to slidably receive an arm of the frame connector 7270A.

As such, the connection between the first holder 7210 and the third holder 7240 can be secured when one arm of the frame connector 7270A is inserted within the inner channel 7216 of the first holder 7210 (FIG. 7E), and another arm of the frame connector 7270A is inserted within the inner channel 7248 of the third holder 7240. In this embodiment, the means of connection between the other holders via the frame connectors are generally similar to the means of connection between the first holder 7210 and the third holder 7240 via the frame connector 7270A as described above. As such, when the system 7000 is in the assembled state (as shown in FIG. 7B), the frame connectors are not exposed at the exterior of the reusable frame 7200, such that the reusable frame has a neat and better appearance.

In this embodiment as shown in FIG. 7F, the third holder 7240 further includes an upper recess 7244A extending along the length of the upper ridge 7244, and a lower recess 7245A extending along the length of the lower ridge 7245. The upper recess 7244A and the lower recess 7245A are sized and shaped to receive and secure an end pleat of the filter at the first side (as shown in FIG. 7G). Although not shown, it is understood that the fourth holder (not shown) is structurally similar to the third holder and further includes upper recess and lower recess to receive and secure the opposing end pleat of the filter at the second side.

Still referring to FIG. 7F, the upper holder flap 7242 of the third holder 7240 includes two notches 7246 and 7247 for connecting with the pleat spacers. In this embodiment, the notch 7246 is formed from a rectangular (or square) piece 7246A carved out from the upper holder flap 7242 with one longitudinal side still attached to the upper holder flap 7242 and the other side bent downwardly at a certain angle towards the third plate 7241, thereby forming a hole 7246B on the upper holder flap 7242. In this embodiment, the pleat spacer 7231 has a loop-shaped end 7231A with a diameter slightly larger than the length of the longitudinal side of the rectangular piece 7246A. The rectangular piece 7246A serves as an anchor for the loop-shaped end 7231A of the pleat spacer 7231 to attach thereon, thereby securing the connection of the pleat spacer 7231 with the third holder 7240. The notch 7247 has a similar structure with the notch 7246 for securing the connection of another pleat spacer (not shown) with the third holder 7240.

Now referring to FIG. 7G, which shows the interaction between the pleat spacer 7231, the filter 7100 and the third holder 7240 when the system is in the assembled state. The pleat spacer 7231 is connected to the third holder 7240 via the attachment of the loop-shaped end 7231A with the notch 7246, and extended generally perpendicular to the direction of pleating of the filter 7100. In this embodiment, each coil 7231C of the pleat spacer 7231 has a coils width that generally matches the pleat width of the pleats 7110, such that each pleat 7110 can be contained within the winding of each coil 7231C, thereby providing a strong mechanical support to the filter 7100 and maintaining a spaced, pleat profile of the filter 7100 when the system is in an assembled state. The upper recess 7244A and the lower recess 7245A together receive and secure the last pleat of the filter 7100 at the first side, thereby securing the connection between the filter 7100 and the third holder 7240. Collectively, the upper recesses and the lower recesses of the third holder and the fourth holder secures the first side and the second side of the filter to the reusable frame, respectively. In one example, the pleat spacer 7231 is a cylindrical coil spring that is made of metals (e.g. aluminum), alloys such as steel, plastics such as PC, ABS, PVC, elastomers such as EPDM, or Silicone rubber.

### Example Embodiment 7: Example Pleat Spacer 8231

Now referring to FIG. 8, which shows another embodiment of an example pleat spacer that can be adopted in any reusable frames and systems described herein. FIG. 8 shows the interaction between the pleat spacer 8231, the filter 8100 and the third holder 8240 when the system is in the assembled state. In this embodiment, the filter 8100 and the third holder 8240 has a generally similar structure with the filter and the third holder as described in example embodiment 6. The pleat spacer 8231 is provided in form of a zig-zag shaped piece that generally follows the pleat profile of the plurality of longitudinally extending pleats 8110 and extended generally perpendicular to the direction of pleating of the filter 8100, thereby providing a strong mechanical support to the filter 8100 and maintaining a spaced, pleat profile of the filter 8100 when the system is in an assembled state. In this example, pleat spacer is 8231 is a zig-zag shaped (with smooth corners) spring or wire made of rigid materials such as metal and alloys or plastics. This example pleat spacer 8231 may be adopted to any one of the other example embodiments described herein.

### Example Embodiment 8: Reusable Filter Frame 9200 and System 9000

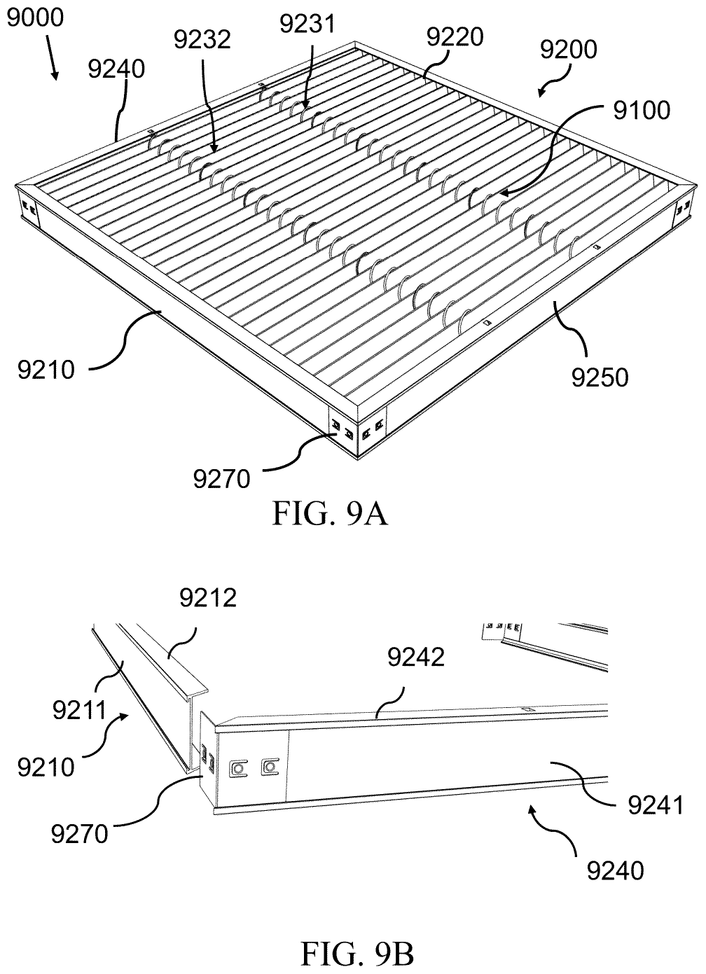

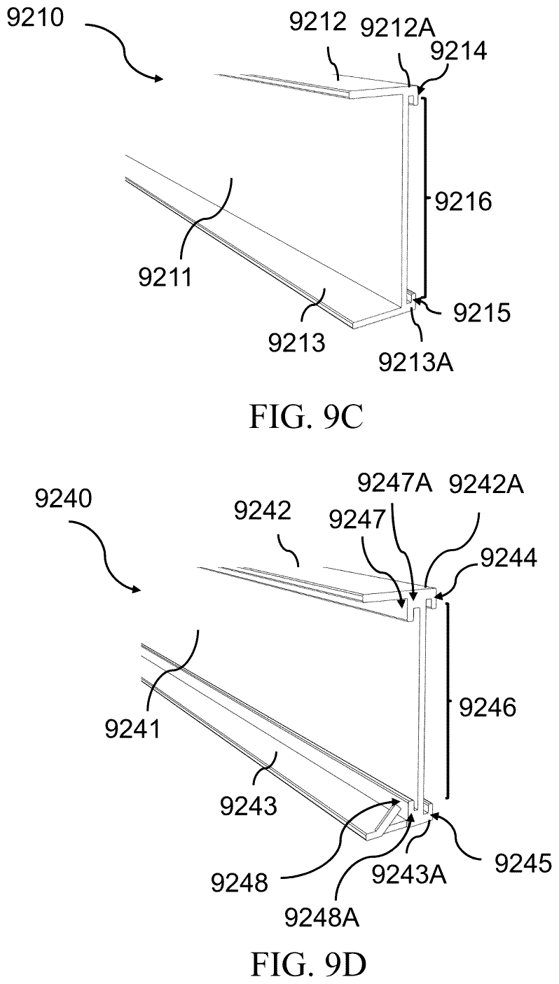

FIG. 9A shows a perspective view of another example reusable filter system 9000 in an assembled state. The filter system 9000 has a generally similar structure to the filter system 7000 as described in example embodiment 6, including, a reusable frame 9200 for an interchangeable filter material 9100, and two pleat spacers 9231 and 9232.

The reusable frame 9200 includes a first holder 9210, a second holder 9220, a third holder 9240, and a fourth holder 9250. In this embodiment, the frame 9200 further includes four frame connectors 9270 (though only three are shown in FIG. 9A) configured to reversibly connect the first holder 9210, the second holder 9220, the third holder 9240, and the fourth holder 9250 with each other to form the reusable frame 9200. In this example embodiment, the upper ridges and the lower ridges (and thus the gap) of the holders are provided at the outer side and the frame connectors 9270 are exposed at the exterior of the reusable frame 9200 when the system is in the assembled state, and the structures and connections of the holders and the frame connectors are different from those as described in example embodiment 6, which will be described in more detail together with FIGS. 9B-9D.

Now referring to FIGS. 9B-9D. FIG. 9B illustrates the connections between the first holder 9210 and the third holder 9240 via the frame connector 9270. Referring to FIGS. 9B and 9C, the first holder 9210 includes an elongated first plate 9211, an upper holder flap 9212 extended along the top, longitudinal side of the first plate 9211, and a lower holder flap 9213 extended along the bottom, longitudinal side of the first plate 9211. In this embodiment, the upper holder flap 9212 has an extended portion 9212A projecting outwardly towards the exterior of the first plate 9211. The first holder 9210 further includes an upper ridge 9214 at the outer side of the first plate 9211, extending downwardly and generally perpendicularly from the extended portion 9212A of the upper holder flap 9212 along the length of the upper holder flap 9212, defining a gap between the upper ridge 9214 and the outer side of the first plate 9211. Similarly, the lower holder flap 9213 has an extended portion 9213A at the outer side of the first plate 9211, projecting outwardly towards the exterior of the first plate 9211. The first holder 9210 further includes a lower ridge 9215 extending upwardly and generally perpendicularly from the extended portion 9213A of the lower holder flap 9213 along the length of the lower holder flap 9213, defining a gap between the lower ridge 9215 and the outer side of the first plate 9211. The width of the gap between the upper ridge 9214 and the outer side of the first plate 9211 is generally the same with the width of the gap between the lower ridge 9215 and the outer side of the first plate 9211, and both gaps together form an outer channel 9216 adapted to slidably receive an arm of the frame connector 9270.

Referring now to FIG. 9D, the third holder 9240 includes an elongated third plate 9241, an upper holder flap 9242 extended along the top, longitudinal side of the third plate 9241, and a lower holder flap 9243 extended along the bottom, longitudinal side of the third plate 9241. In this embodiment, the upper holder flap 9242 has an extended portion 9242A projecting outwardly towards the exterior of the third plate 9241. The third holder 9240 further includes an upper ridge 9244 at the outer side of the first plate 9211, extending downwardly and generally perpendicularly from the extended portion 9242A of the upper holder flap 9242 along the length of the upper holder flap 9242, defining a gap between the upper ridge 9244 and the outer side of the third plate 9241. Similarly, the lower holder flap 9243 has an extended portion 9243A projecting outwardly towards the exterior of the third plate 9241. The third holder 9240 further includes a lower ridge 9245 extending upwardly and generally perpendicularly from the extended portion 9243A of the lower holder flap 9243 along the length of the lower holder flap 9243, defining a gap between the lower ridge 9245 and the outer side of the third plate 9241. The width of the gap between the upper ridge 9244 and the outer side of the third plate 9241 is generally the same with the width of the gap between the lower ridge 9245 and the outer side of the third plate 9241, and both gaps together form an outer channel 9246 adapted to slidably receive an arm of the frame connector 9270.

As such, referring to FIG. 9B-9D together, the connection between the first holder 9210 and the third holder 9240 can be secured when one arm of the frame connector 9270 is inserted within the outer channel 9216 of the first holder 9210 (FIG. 9C), and another arm of the frame connector 9270 is inserted within the outer channel 9246 of the third holder 9240 (FIG. 9D).

In this embodiment, the means of connection between the other holders via the frame connectors are generally similar to the means of connection between the first holder 9210 and the third holder 9240 via the frame connector 9270 as described above. As such, when the system 9000 is in the assembled state (as shown in FIG. 9A), the frame connectors are installed at the outer side of the reusable frame 9200.

Referring back to FIG. 9D, the third holder 9240 further includes an interior upper ridge 9247 extending downwardly and generally perpendicularly from the upper holder flap 9242 at the inner side of the third plate 9241, and an upper recess 9247A extending along the length of the interior upper ridge 9247. Similarly, the third holder 9240 further includes an interior lower ridge 9248 extending upwardly and generally perpendicularly from the lower holder flap 9243 at the inner side of the third plate 9241, and a lower recess 9248A extending along the length of the interior lower ridge 9248. The upper recess 9247A and the lower recess 9248A are adapted to receive and secure a pleat of the filter at the first side (not shown).

### Example Embodiment 9: Reusable Filter Frame 10200 and System 10000

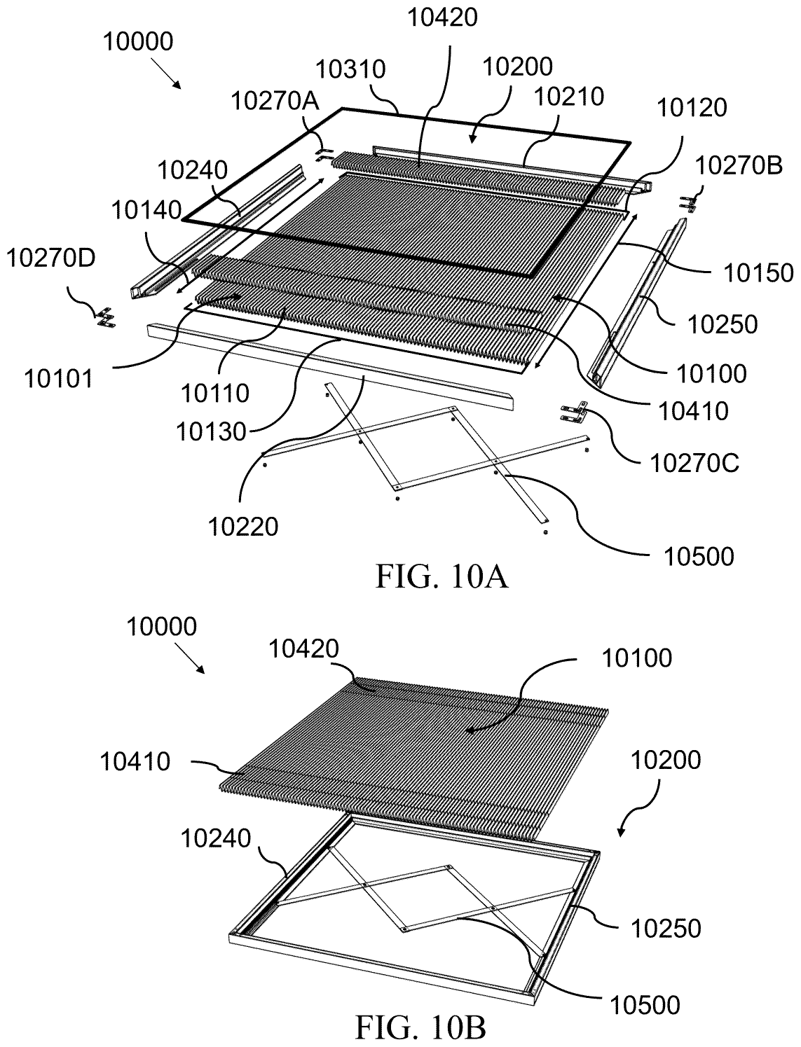

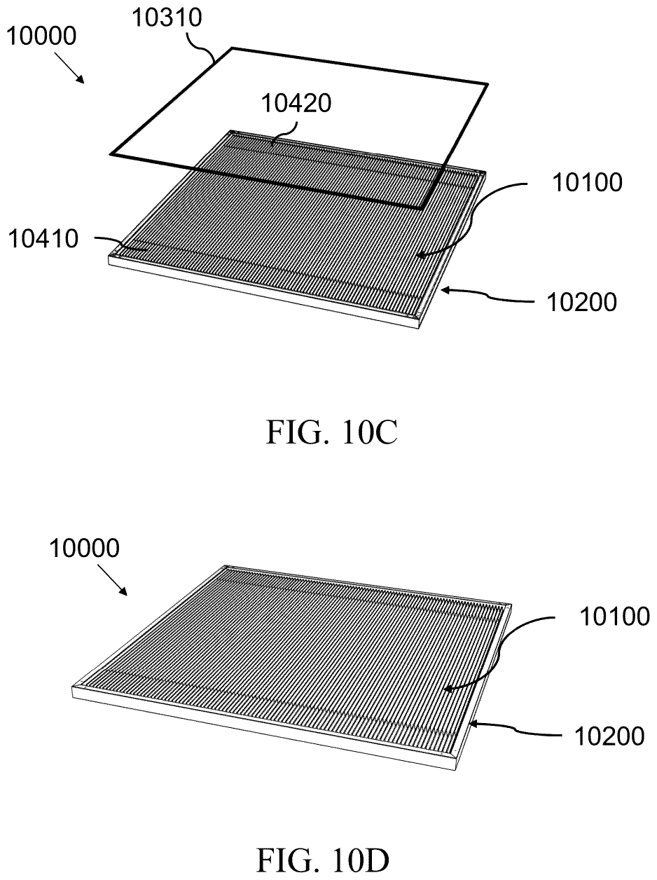

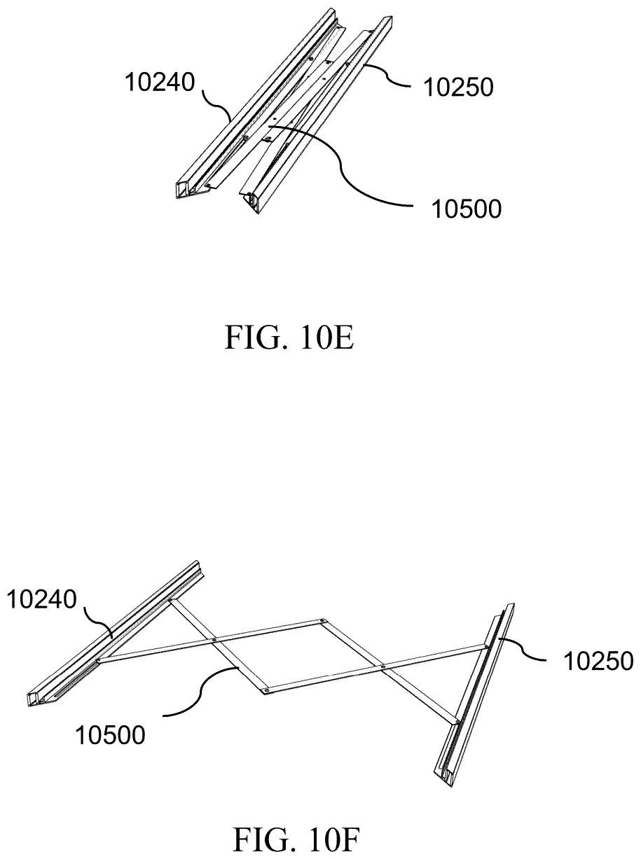

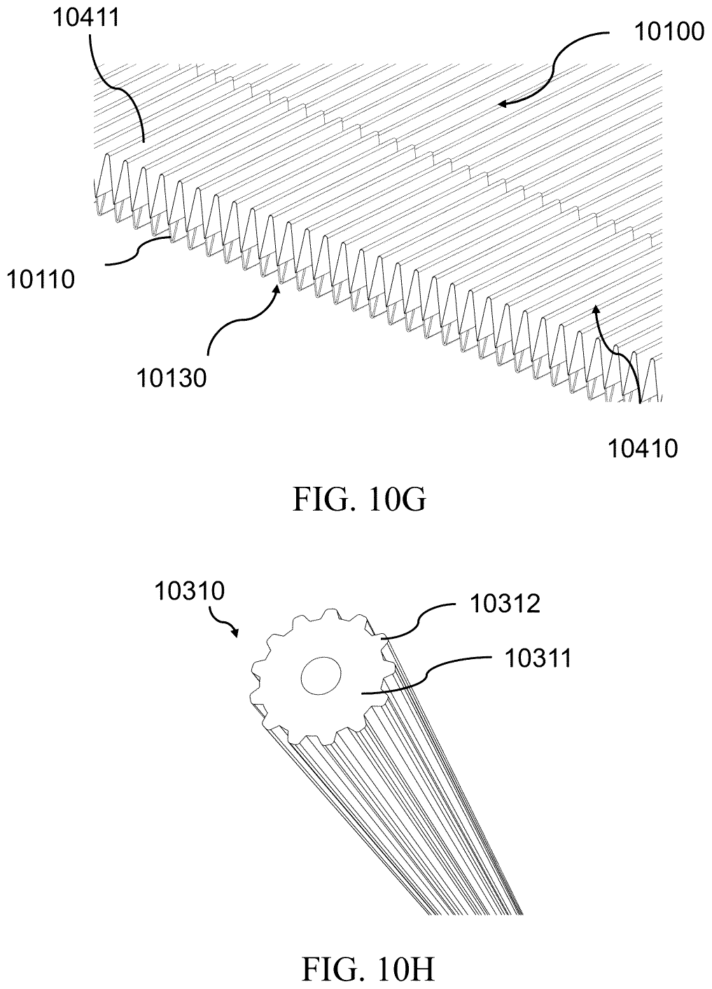

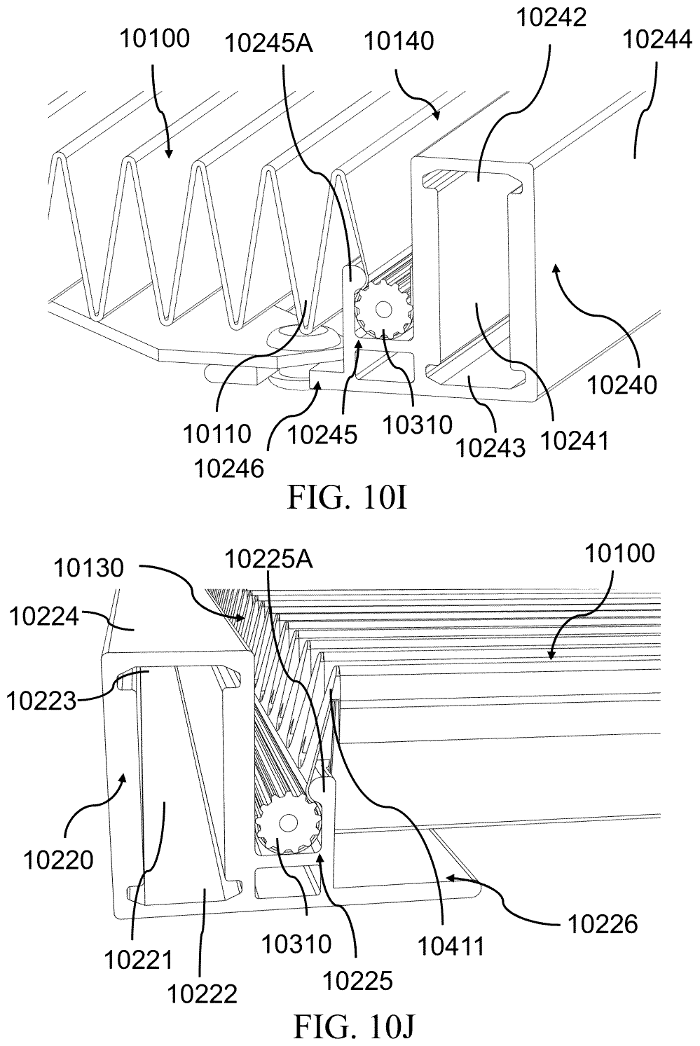

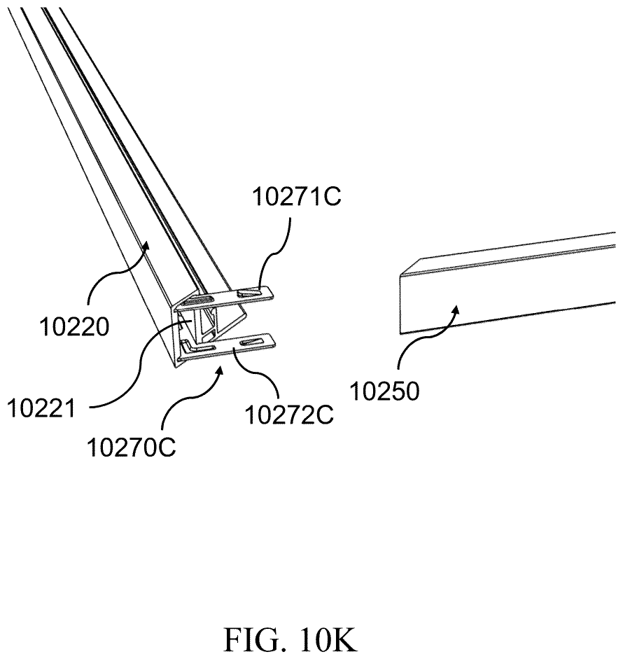

FIG. 10A-10K show another example reusable filter system 10000 which generally includes a reusable frame 10200, two pleated, flexible sheets 10410 and 10420, and a spline 10310. FIG. 10A is a perspective exploded view of the example reusable filter system 10000. The filter system 10000 includes a reusable frame 10200 which holds the interchangeable filter material 10100. The filter 10100 includes a plurality of longitudinally extending pleats 10110. Each pleat has a pleat height, a pleat width and a cross-section defining a pleat profile when it is expanded in an assembled state. The filter 10100 has a first pleated edge 10120 generally perpendicular to a direction of pleating and an opposing, second pleated edge 10130, a first side 10140 generally parallel to the direction of pleating and an opposing, second side 10150, and an upper pleated face 10101 and an opposing, lower pleated face (not shown). The filter 10100 is structurally similar to the filter described in example embodiment 6. In this example, the reusable system 10000 or the reusable frame 10200 do not include pleat spacer. Optionally, one or more pleat spacers described in any example embodiments may be included in the reusable system 10000 or the reusable frame 10200.

Still referring to FIG. 10A, the reusable frame 10200 includes a first holder 10210, a second holder 10220, a third holder 10240, and a fourth holder 10250. The first and second holders 10210, 10220 are sized and shaped to cover and support the plurality of pleats of the filter 10100 along the first pleated edge 10120 and the second pleated edge 10130, respectively. The third and fourth holders 10240, 10250 are sized and shaped to cover and support the filter 10100 along the first and second sides 10140, 10150, respectively. In this embodiment, the frame 10200 further includes four pairs of frame connectors 10270A-10270D adapted to reversibly connect two longitudinal ends of any two of the first holder 10210, the second holder 10220, the third holder 10240, and the fourth holder 10250 with each other. The structures and connections of the holders and the frame connectors will be more clearly shown in FIG. 10I-10K and described in more detail. In one example, the holders and the connectors may be made of hard materials such as metals (e.g., aluminum), alloys (e.g., steel), plastics such as PC, ABS, PVC, elastomers such as EPDM, or Silicone rubber.

Now referring to FIGS. 10A, the reusable frame 10200 further includes a spline 10310, a supporting piece 10500, and two flexible sheets 10410 and 10420. Referring to FIGS. 10A-10D and 10H, in this example, spline 10310 is elongated, flexible cord fit for the frame 10200. The spline can be made of any flexible materials such as vinyl, plastics, rubber, polyfoam, composites, sponge cord and combinations thereof. FIG. 10H shows a close up view of a portion of the spline 10310. In this example, the spline 10310 has a general circular cross section, with a plurality of spline ridges 10312 (13 spline ridges in this example) protruding outwardly along the length of the spline to provide a better grip and compression when it is pressed into the spline receiving portion of the frame. The spline 10310 also includes a hollow core along the length to provide more flexibility and save material costs. The hollow core may also act as a buffer in terms of overall diameter and hardness in order to facilitate the spline to be easily inserted into/removed from the spline receiving portion. Referring to FIGS. 10A, 10B, 10E and 10F, the supporting piece 10500 is two pairs of cross pieces (or scissor grids) pivotally connected with each other in one direction, each pair of the cross pieces are pivotally connected at a central coupling point, wherein the two pairs of cross pieces are configured to connect the third and the fourth holders 10240, 10250 so that the third and the fourth holders 10240, 10250 can be switched between a spaced/assembling position (i.e., ready for use in assembled state) (FIG. 10F) and a proximate/dissembling position (i.e., ready for use in dissembled state) (FIG. 10E) from each other. Providing the third and fourth holders connected and switchable between expandable and collapsible states will make the step of assembling of the reusable frame easier and thus more user friendly. The supporting piece 10500 is configured to fixedly connect with the third and the fourth holders 10240, 10250.

Now referring to FIGS. 10A, 10B and 10G, the two flexible sheets 10410 and 10420 are fixedly or reversibly attached to a portion of the upper pleat tip face, generally following the pleat profile and extending outwardly from the first pleated edge 10130 and the second pleated edge 10210 to form a first pleated edge extension and a second pleated edge extension, respectively. With the flexible sheets, all the pleated edges and sides of the filter can be secured directly or indirectly to the reusable frame, avoiding air directly by-pass or leak from the edges or sides. They also allow the reusable frames and systems be universal and can adopt to various sizes and applications, and allow larger tolerances in the dimensions of the reusable frames and the filters during manufacturing.

FIGS. 10C, 10D, 10I and 10J show the same filter system 10000 in an assembled state. The first, second, third and fourth holders are connected together via the frame connectors to form a square shaped frame 10200 and a cavity therein to receive the filter 10100, which is attached with flexible sheets 10410 and 10420. Referring to FIG. 10I, the third holder 10240 includes a generally cuboid elongated body 10244 having a hollow area 10241, a raised, spline receiving portion 10245 disposed at the inner side of the body and a bottom horizontal plate 10246 extending inwardly from the inner bottom edge of the body 10244. The hollow area 10241 has a capital letter “I”-shaped cross-section having two extended connector receiving portions 10242 and 10243 at the two vertical ends. The two connector receiving portions 10242 and 10243 are sized and shaped to receive a pair of frame connectors such as 10270D, respectively. The spline receiving portion 10245 includes a ridge 10245A and is sized and shaped to frictionally limit the spline therein. In this example, the fourth holder is structurally similar and shall not be repeated here. Collectively, the spline receiving portions of the third holder and the fourth holder secures the first side and the second side of the filter to the reusable frame, respectively, by installing the spline to the spline receiving portion.

Now referring to FIG. 10J, the second holder 10220 is structurally similar to the third holder 10240 in that it also includes a generally cuboid elongated body 10224 having a hollow area 10221, a raised, spline receiving portion 10225 disposed at the inner side of the body and a bottom horizontal plate 10226 extending inwardly from the inner bottom edge of the body 10224. The hollow area 10221 has a capital letter “I”-shaped cross-section having two extended connector receiving portions 10222 and 10223 at the two vertical ends. The two connector receiving portions 10222 and 10223 are sized and shaped to receive a pair of frame connectors such as 10270D, respectively. The spline receiving portion 10225 includes a ridge 10225A and is sized and shaped to frictionally limit the spline therein. In this example, the first holder is structurally similar and shall not be repeated here. Because the first pleated edge and the second pleated edge of the filter are attached with flexible sheets, respectively, the flexible sheets can be deformed and fit into the spline receiving portion 10225 when the spline is installed. Collectively, the spline receiving portions of the third holder and the fourth holder indirectly secures the first pleated edge and the second pleated edge of the filter to the reusable frame, respectively, by installing the spline to the spline receiving portion.

Now referring to FIG. 10K, the second holder 10220 and the fourth holder 10250 can be reversibly connected by a pair of frame connectors 10270C. The pair of frame connectors 10270C includes an upper frame connector 10271C and lower frame connectors 10272C, each L-shaped frame connector includes a connector notch proximate to the ends, thereby providing a frictional snap fit between the connectors and the holders.

### Example Embodiment 10: Reusable Filter Frame 11200 and System 11000

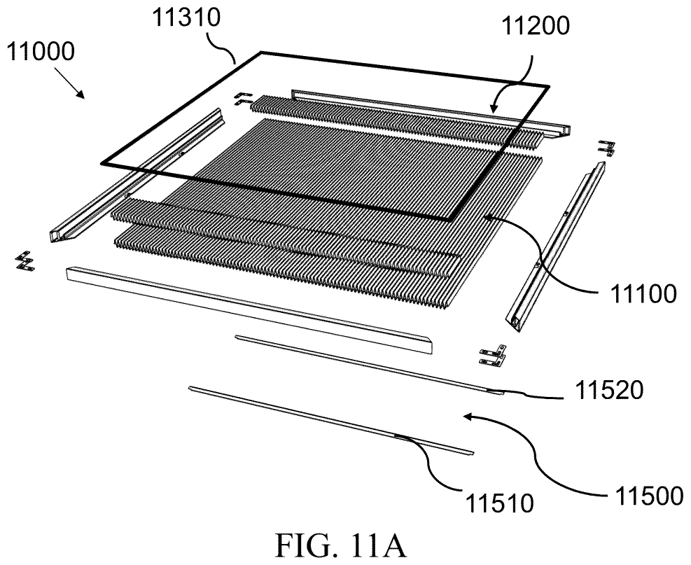

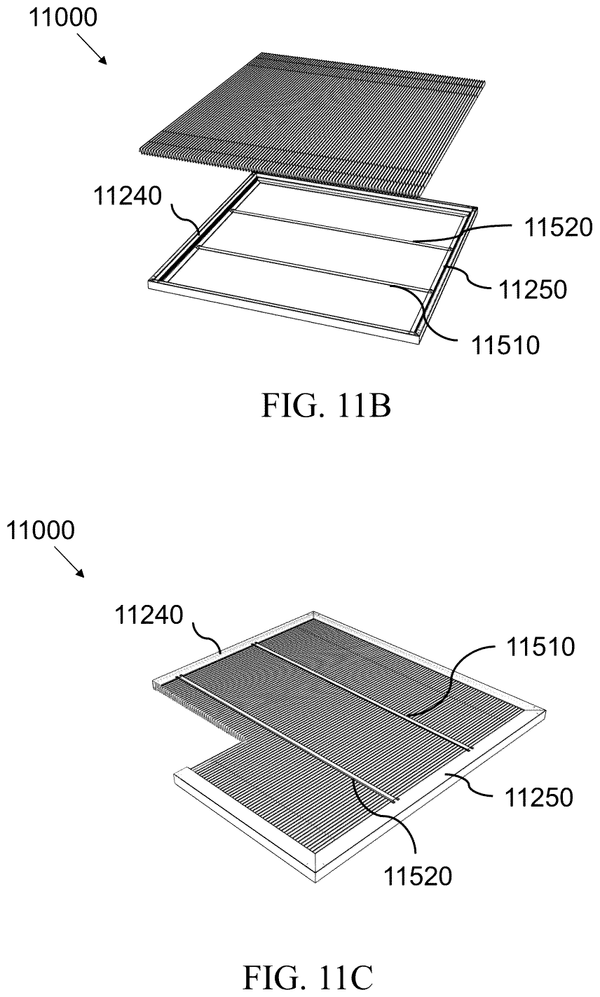

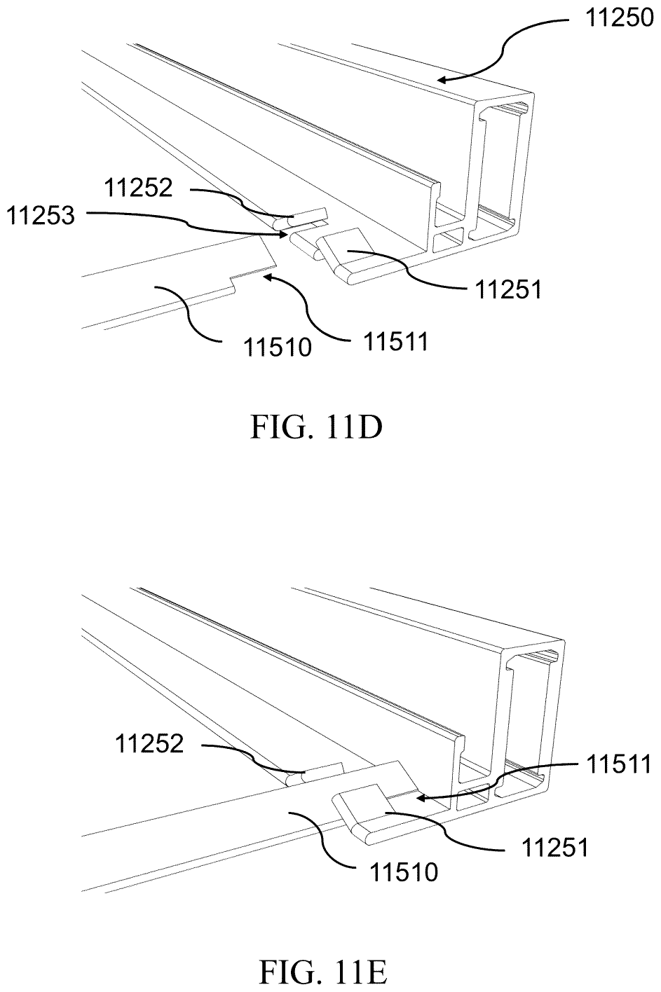

FIG. 11A-11D show another example reusable filter system 11000 which generally similar to example reusable filter system 10000 in example embodiment 9, but further comprises supporting pieces 11500. The reusable filter system 11000 includes a reusable frame 11200, two pleated, flexible sheets, a spline 11310 and supporting pieces 11500. The two supporting pieces 11510 and 11520 are rigid strip with a cross-section in a trough shape, and are configured to reversibly connect with the third holder 11240 and the fourth holder 11250. The supporting pieces 11500 provide mechanical support to the reusable frame and system to withstand back pressure and avoid deformation, especially for applications requiring high air flow volume. Now referring to FIGS. 11D and 11E, showing the fourth holder 11250 is structurally similar to the example embodiment 9, but along its length provided is a pair of cuts 11251 and 11252, each cut are slant upwards at an angle to form a supporting piece receiving portion. Each end of the supporting piece 11510 includes an indent 11511 at each side, sized and shaped to match with the supporting piece receiving portion formed by the cuts 11251 and 11252. As such, the supporting pieces can be reversibly attached to the holders.

### Example Embodiment 11: Reusable Filter Frame 12200 and System 12000

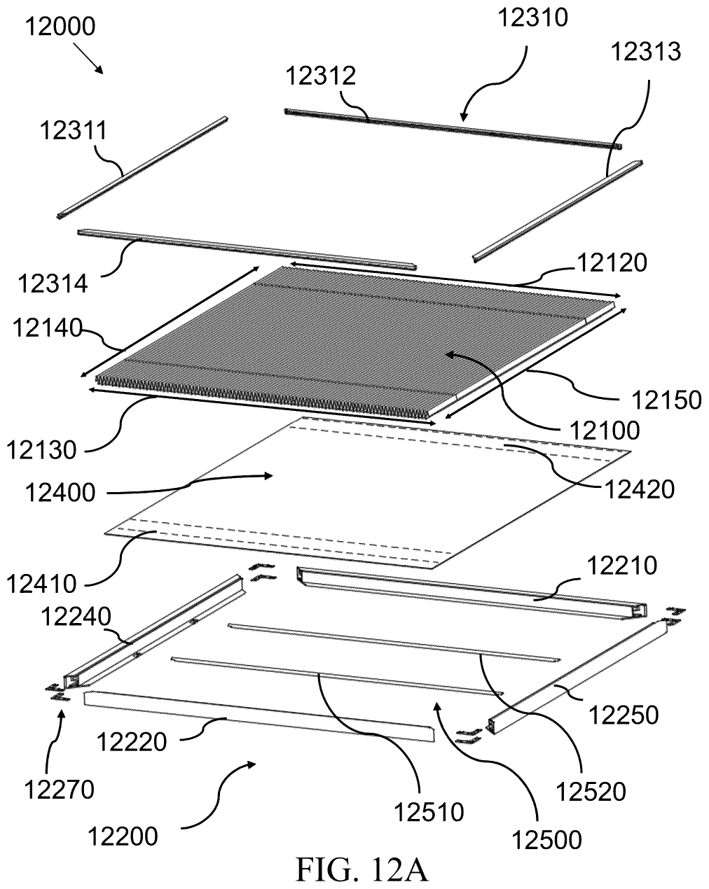

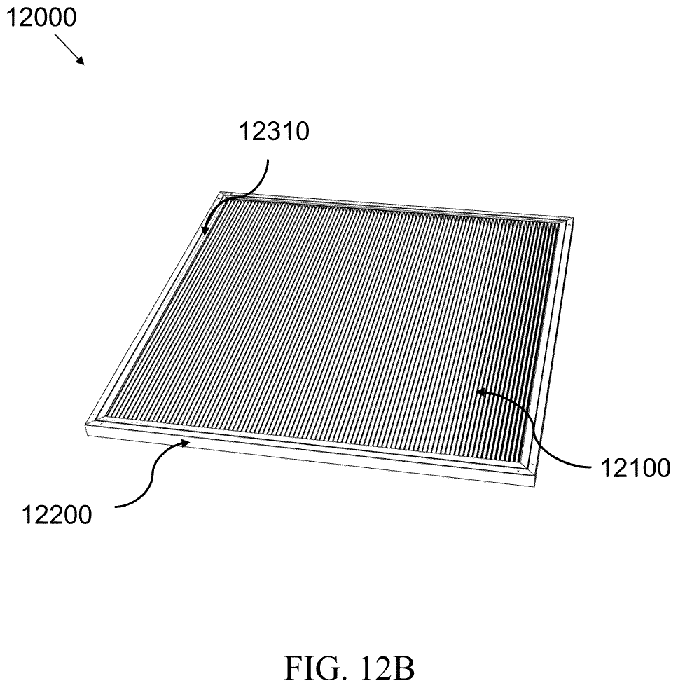

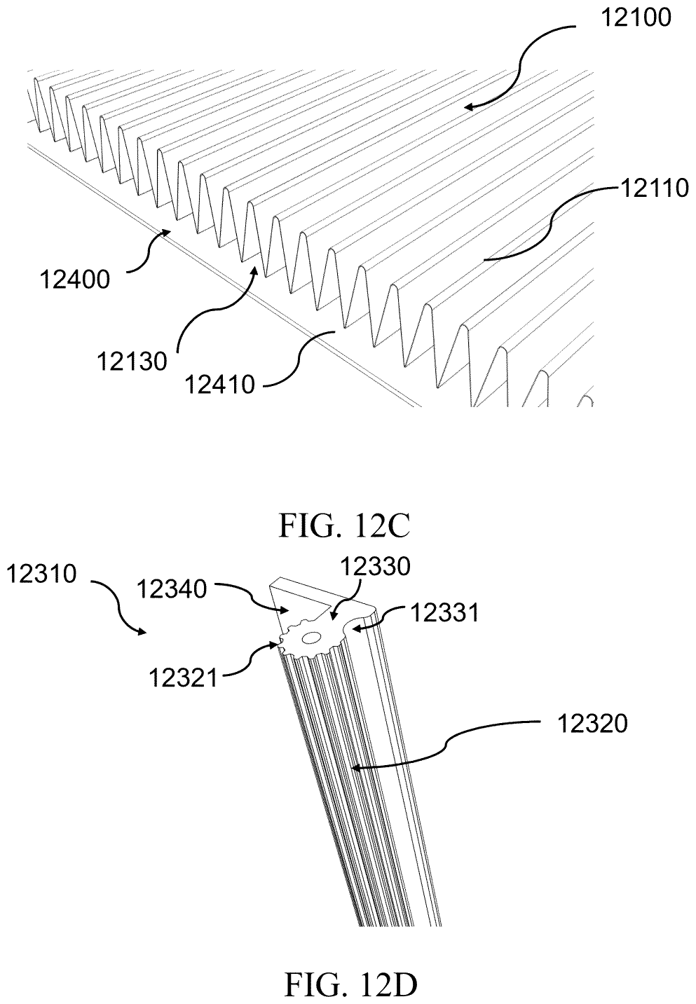

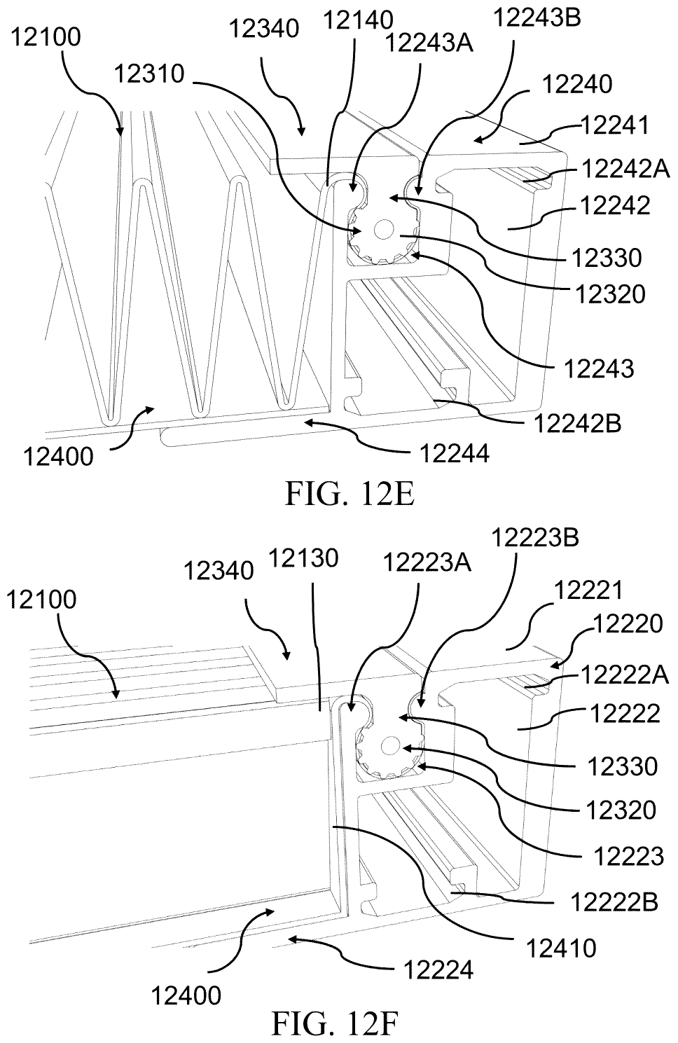

FIG. 12A-12F show another example reusable filter system 12000 which generally similar to example reusable filter system 11000 in example embodiment 10, but the flexible sheet 12400 is provided as a generally flat, single piece of sheet 12400 sized and shaped sufficient to cover entire lower pleat tip face and to extend outwardly from the first pleated edge 12130 and the second pleated edge 12120 of the filter 12100. The reusable filter system 12000 includes a reusable frame 12200 for filter 12100, a flexible sheet 12400, two supporting pieces 12500 (left supporting piece 12510 and right supporting piece 12520) and four pieces of splines 12000. In this example, the flexible sheet 12400 is attached to the entire filter 12100 at the lower pleat tips. The flexible sheet 12400 is made of air permeable materials such as plastic extruded mesh, plastic expanded mesh or non-woven tissue, non-woven mesh, non-woven fabric, or elastic non-woven fabric. With the flexible sheet, all the pleated edges and sides of the filter 12100 can be secured directly or indirectly to the reusable frame, avoiding air directly by-pass or leak from the edges or sides. In addition, because all the pleats are attached to the flexible sheet (at least at one face or both faces), the flexible sheet also provides certain mechanical support to the filter (i.e., also acts as a supporting piece to the reusable frame) and maintain pleat spacing (i.e., also acts as a pleat spacer). It also allows the reusable frames and systems be universal and can adopt to various sizes and applications, and allows larger tolerances in the dimensions of the reusable frames and the filters during manufacturing.

Now referring to FIGS. 12A and 12D, in this example, splines 12310 are four pieces of elongated, flexible cords fit for the frame 10200. Alternatively, one pieces of spline can be used. The splines can be made of any flexible materials such as vinyl, plastics, rubber, polyfoam, composites, sponge cord and combinations thereof. FIG. 12D shows a close up view of a portion of a spline 12310. In this example, the spline 12310 has a spline body 12320 having a general circular cross section, with 10 spline ridges 12321 protruding outwardly along the length of the spline 12310 to provide a better grip and compression when it is pressed into the spline receiving portion of the frame. The spline 12310 also includes a hollow core along the length to provide more flexibility and save material costs. The hollow core may also act as a buffer in terms of overall diameter and hardness in order to facilitate the spline to be easily inserted into/removed from the spline receiving portion. The spline 12310 further includes a spline flap piece 12340 and neck portion 12330 which connects the spline body and the spline flap piece 12340. The neck portion 12330 further comprises a dent 12331 at one exposed side. Alternatively, the neck portion 12330 may further comprise two dents 12331 at both exposed sides. Alternatively, the neck portion 12330 may not comprise any dents 12331 at the exposed sides.

Referring to FIG. 12E, the third holder 12240 includes a generally cuboid elongated body 12241 having a hollow area 12242, a even more raised, spline receiving portion 12243 disposed at the inner side of the body and a bottom horizontal plate 12244 extending inwardly from the inner bottom edge of the body 12241. The hollow area 12242 has a capital letter “L”-shaped cross-section having two extended connector receiving portions 12242A and 12242B at the upper and lower ends with different relative vertical positions. The two connector receiving portions 12242A and 12242B are sized and shaped to receive a pair of frame connectors such as 12270, respectively. The spline receiving portion further includes two ridges sized and shaped to match with the corresponding dent to limit the spline in the spline receiving portion. The spline receiving portion 12243 includes two ridges 12243A and 12243B and are sized and shaped to frictionally limit the spline body 12320 at the neck portion 12330. In other words, the gap between the two ridges 12243A and 12243B are configured to allow securing the spline 12320 at the neck portion 12330. The spline receiving portion is configured such that it allows the spline flap piece at a position just slightly above the filter, allowing the spline flap piece 12340 to limit the first side 12140 of the filter 12100. The spline flap piece 12340 substantially levels with the top face of third holder 12240. In this example, the fourth holder is structurally similar and shall not be repeated here. Collectively, the spline receiving portions of the third holder and the fourth holder secures the first side and the second side of the filter to the reusable frame, respectively, by installing the spline to the spline receiving portion. Now referring to FIG. 12F, the second holder 12220 is structurally similar to the third holder 12240 in that the third holder 12240 also includes a generally cuboid elongated body 12221 having a hollow area 12222, a even more raised, spline receiving portion 12223 disposed at the inner side of the body and a bottom horizontal plate 12224 extending inwardly from the inner bottom edge of the body 12221. The hollow area 12222 has a capital letter “L”-shaped cross-section having two extended connector receiving portions 1222A and 1222B at the upper and lower ends with different relative vertical positions. The two connector receiving portions 1222A and 1222B are sized and shaped to receive a pair of frame connectors such as 12270, respectively. The spline receiving portion 12223 includes two ridges 12223A and 12223B and are sized and shaped to frictionally limit the spline body 12320 at the neck portion 12330. In other words, the gap between the two ridges 12223A and 12223B are configured to allow securing the spline 12340 at the neck portion 12330. The spline receiving portion is configured such that it allows the spline flap piece at a position just slightly above the filter, allowing the spline flap piece 12340 to limit the first pleated edge 12130 of the filter 12100. The spline flap piece 12340 substantially levels with the top face of third holder 12240. In this example, the first holder is structurally similar and shall not be repeated here. Because the first pleated edge and the second pleated edge of the filter are attached with the flexible sheet 12400, the extended flexible sheet can be deformed and fit into the spline receiving portion 12320 when the spline is installed. Collectively, the spline receiving portions of the first holder and the second holder indirectly secures the first pleated edge and the second pleated edge of the filter to the reusable frame, respectively, by installing the spline to the spline receiving portion. In another example, the example reusable filter system 12000 does not include the two supporting pieces 12500 (left supporting piece 12510 and right supporting piece 12520).

### Example Embodiment 12: Reusable Filter Frame 13200 and System 13000

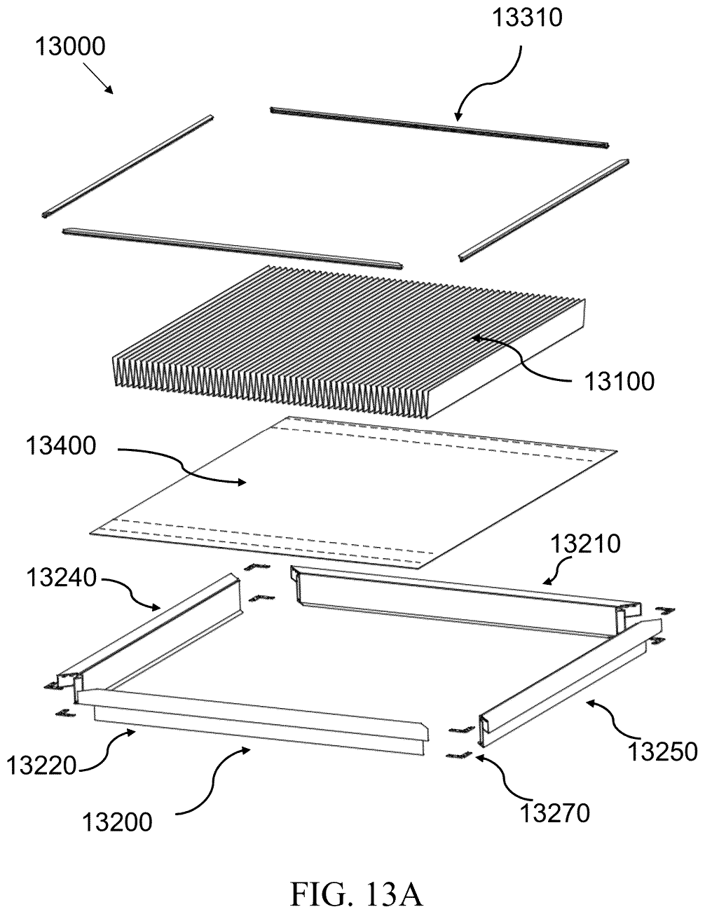

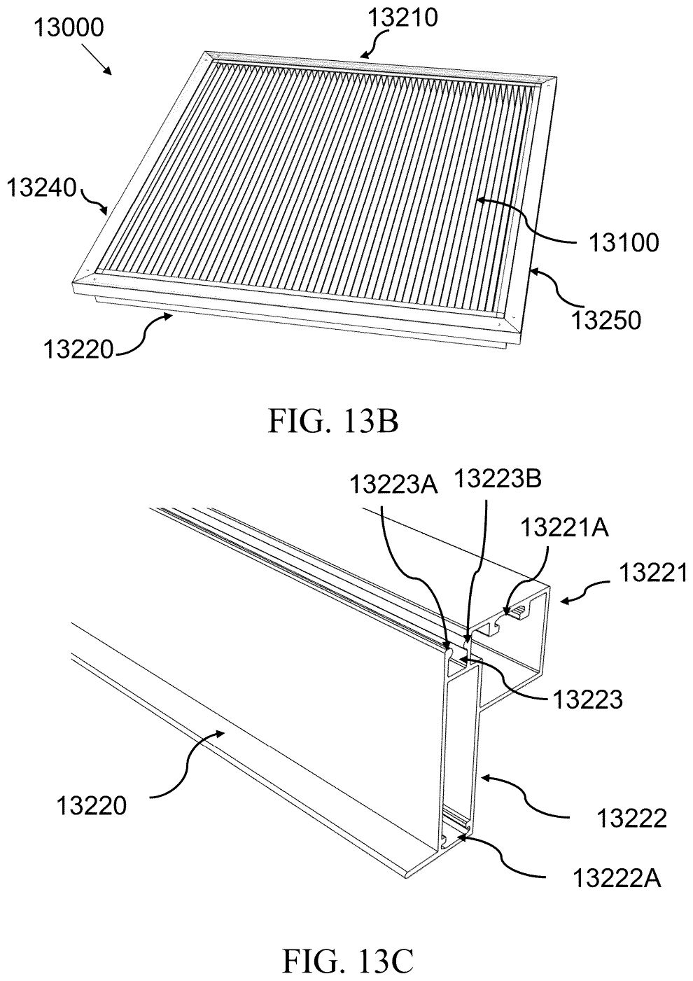

FIG. 13A-13C show another example reusable filter system 13000 which generally similar to example reusable filter system 12000 in example embodiment 11, but the specific structures of the first, second, third and fourth holders 13210, 13220, 13240 and 13250 (and thus the reusable frame 13200) is different, to adapt for the filter 13100 which has a larger pleat height. The reusable filter system 13000 includes a reusable frame 13200 for filter 13100, a flexible sheet 13400, and four pieces of splines 13310. The four pieces of splines 13310 have structures that are generally similar to the spline 12310 as shown in FIG. 12D. In this example, the flexible sheet 13400 is attached to the entire filter 13100 at the lower pleat tips. The flexible sheet 13400 is made of air permeable materials such as plastic extruded mesh, plastic expanded mesh or non-woven tissue, non-woven mesh, non-woven fabric, or elastic non-woven fabric. With the flexible sheet, all the pleated edges and sides of the filter 13100 can be secured directly or indirectly to the reusable frame, avoiding air directly by-pass or leakage from the edges or sides. It also allows the reusable frames and systems be universal and can adopt to various sizes and applications, and allows larger tolerances in the dimensions of the reusable frames and the filters during manufacturing.

Referring FIG. 13C, the second holder 13220 includes a flange piece 13221, a rectangular shaped, vertical extension piece 13222, and a spline receiving portion 13223 connected with each other. The spline receiving portion is disposed above the vertical extension piece 13222. The flange piece 13221 includes a frame connector receiving portion 13221A at the upper end. The vertical extension piece 13222 includes a frame connector receiving portion 13222A at the lower end. The two connector receiving portions 13221A and 13222A are sized and shaped to receive a pair of frame connectors such as 13270 (shown in FIG. 13A), respectively. The first, third and fourth holders 13210, 13240, 13250 are structurally similar to the second holder 13220 and shall not be repeated here.

The spline receiving portion further includes two ridges sized and shaped to match with the corresponding dent to limit the spline in the spline receiving portion. The spline receiving portion 13223 includes two ridges 13223A and 13223B and are sized and shaped to frictionally limit the spline body of the spline 13310 (as shown in FIG. 13A) at the neck portion. In other words, the gap between the two ridges 13223A and 13223B are configured to allow securing the spline 13310 at the neck portion. The spline receiving portion is configured such that it allows the spline flap piece at a position just slightly above the filter, allowing the spline flap piece of the spline 13310 to limit the second pleated edge of the filter 13100. The spline flap piece of the spline 13310 substantially levels with the top face of second holder 13220. In this example, the first, third and fourth holders 13210, 13240, 13250 are structurally similar and shall not be repeated here. Collectively, the spline receiving portions of the holders secures all the sides and edges of the filter to the reusable frame, by installing the spline to the spline receiving portion. This specific structure of the reusable frame enables direct adaptation to applications in systems such as AHU. In an alternative example, the filter 13100 is a bag-type filter.

### Example Embodiment 13: Methods of Assembling a Filter System and Reusable Frame

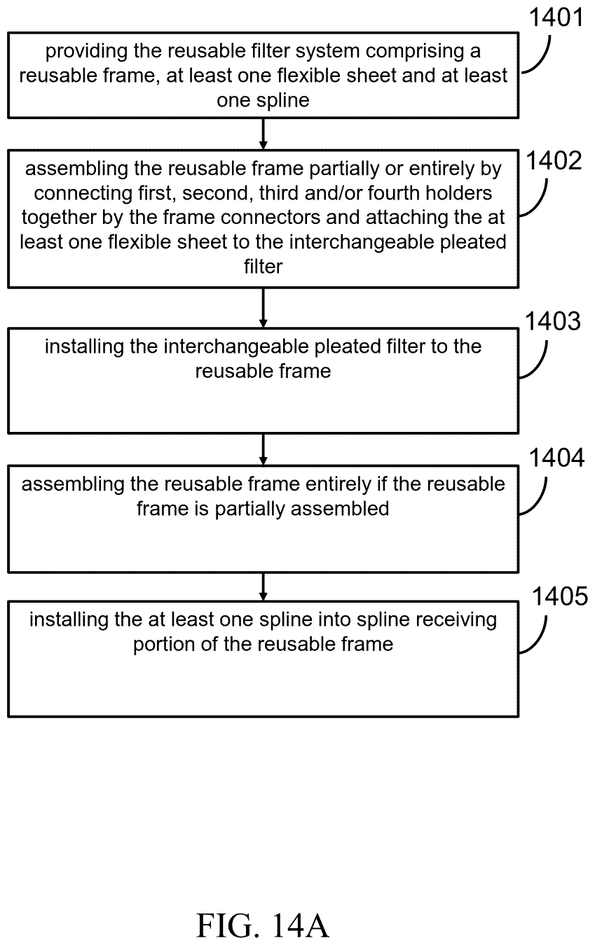

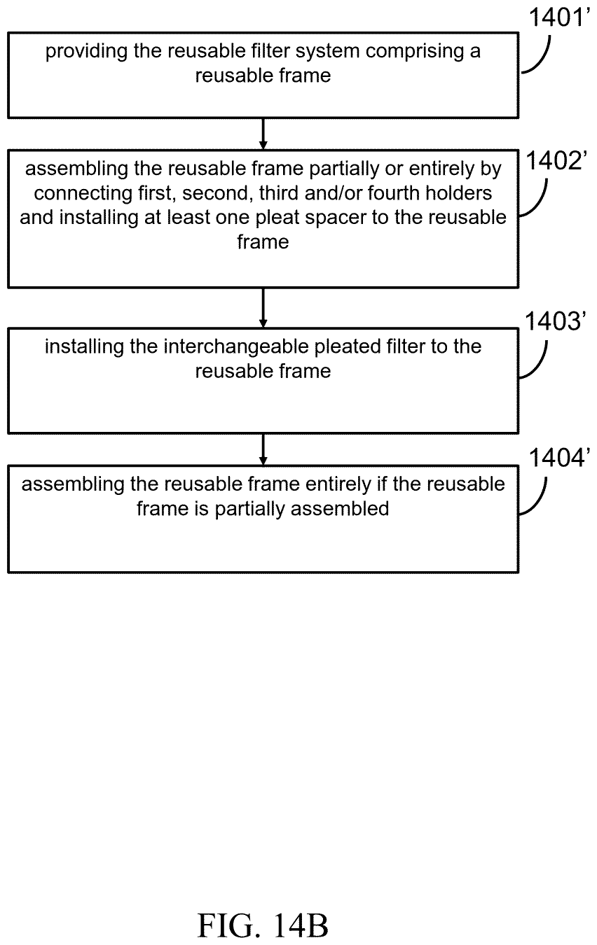

Referring now to FIG. 14A. To assemble a reusable filter system as described in any one of the above example embodiments, the following steps are involved:
(a) step 1401: providing the reusable filter system comprising a reusable frame, at least one flexible sheet and at least one spline as described herein. The reusable frame includes first, second, third and fourth holders and multiple frame connectors. All or at least part of the components of the reusable system are re-used after cleaning. A pleated filter is also provided.
(b) step 1402: assembling the reusable frame partially or entirely by connecting first, second, third and/or fourth holders together by the frame connectors and attaching the at least one flexible sheet to the interchangeable pleated filter. The flexible sheet may be fixedly or reversibly attached to the filter.
(c) step 1403: installing the interchangeable pleated filter to the reusable frame;
(d) step 1404: assembling the reusable frame entirely if the reusable frame in step 1402 is partially assembled; and
(e) step 1405: installing the at least one spline into spline receiving portion of the reusable frame. The spline may be installed by a spline roller.

Optionally, installing at least one pleat spacer to the reusable frame.

Optionally, connecting the first, second, third and fourth holders by a plurality of connectors.

Optionally, installing at least one supporting piece to the reusable frame.

Referring now to FIG. 14B, showing another example method of assembling a filter frame and filter system. To assemble a reusable filter system as described in any one of the above example embodiments, the following steps are involved:
(a) step 1401′: providing the reusable filter system comprising a reusable frame as described herein. The reusable frame includes first, second, third and fourth holders, at least one pleat spacer and optionally multiple frame connectors. All or at least part of the components of the reusable system are re-used after cleaning. A pleated filter is also provided.
(b) step 1402′: assembling the reusable frame partially or entirely by connecting first, second, third and/or fourth holders together and installing at least one pleat spacer to the reusable frame.
(c) step 1403′: installing the interchangeable pleated filter to the reusable frame; and
(d) step 1404′: assembling the reusable frame entirely if the reusable frame in step 1402′ is partially assembled;

Optionally, installing at least one spline to spline receiving portion of the reusable frame.

Optionally, attaching at least one flexible sheet to the interchangeable pleated filter, such as prior to step 1403′.

Optionally, installing at least one supporting piece to the reusable frame.

Optionally, connecting the first, second, third and fourth holders by a plurality of connectors.

In some embodiments, all or at least part of the components of the reusable system are re-used after cleaning.

### Example Embodiment 14: Methods of Packaging the Reusable Filter System for Transportation

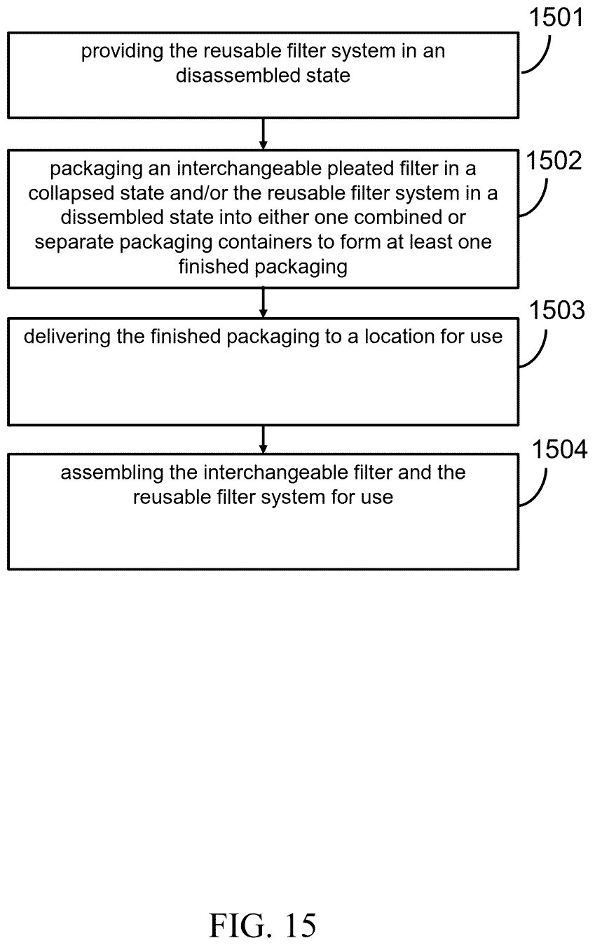

Referring now to FIG. 15, which shows an example of a method of packaging the reusable filter system for transportation with the following steps involved:
(a) step 1501: providing the reusable filter system of as described in any one of the embodiments above in an disassembled state;
(b) step 1502: packaging an interchangeable pleated filter in a collapsed state and/or the reusable filter system comprising the first, second, third and fourth holders (and optionally the other components, such as the spline(s), the flexible sheet(s), the frame connectors and the pleat spacer(s)) in a dissembled state into either one combined or separate packaging containers to form at least one finished packaging, such that volume of space of the finished packaging is significantly reduced;
(c) step 1503: delivering the finished packaging to a location for use; and
(d) step 1504: assembling the interchangeable filter and the reusable filter system for use.

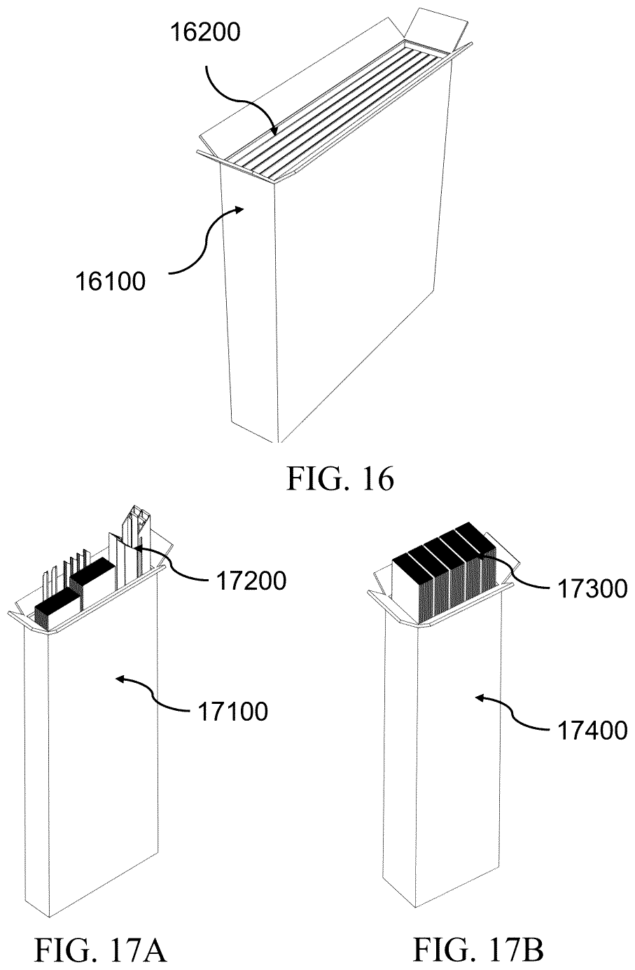

Now referring to FIG. 16. In this embodiment, multiple reusable filter systems 16200 (five in this example), each reusable filter system in the assembled state and installed with an interchangeable filter, are packed together in one box 16100. Referring to FIG. 17A, in this embodiment, the components of the reusable filter system 17200 such as reusable frame (e.g., the first, second, third and fourth holders and connectors) in disassembled state, spline(s), optionally flexible sheet(s) and optionally pleat spacer(s) and supporting piece(s) are packaged together with interchangeable filter(s) in one pack 17100. In some other embodiments, the pack 17100 may only include the components of the reusable filter system 17200 with or without the interchangeable filter(s), and the interchangeable filter(s) are packaged separately or additionally in another pack. For example, as shown in FIG. 17B, five interchangeable filters 17300 (either with or without the flexible sheet) are packaged in a filter pack 17400. In some embodiments, two or more of these filter packs 17400 and/or the packs 17100 as shown in FIG. 17A can also be further packaged into a larger box. By way of example, the filter and the frame (i.e., the first, second, third and fourth holders) may be packaged together in one pack. Other combinations and other numbers of packings can also be used.

By way of example, a used filter system may be dissembled, cleaned and re-used, and the used filter may be disposed. The frame may be reused with a new filter.

### Example Embodiment 15: Uses of the Reusable Filter Systems and Frames

The reusable filter systems and frames described herein have wide applications and uses. In certain examples, the reusable filter systems and reusable frames can be used in any air filtration systems with minimal or even no adaptations. In certain examples, the air filtration systems can be Heating, Ventilation, and Air Conditioning (HVAC), Air Conditioning and Mechanical Ventilation (ACMV), central mechanical ventilation and air conditioning (central MVAC), Variable Refrigerant Volume (VRV) or split, Air Handling Unit (AHU), Makeup Air Unit (MAU), Primary Air Unit (PAU), and/or Fan Coil Unit (FCU). In certain examples, provided is a method of air filtration using the reusable filter system and frames described herein, comprising the step of applying the reusable filter system to an air filtration system. In certain examples, the air filtration system can be Heating, Ventilation, and Air Conditioning (HVAC), Air Conditioning and Mechanical Ventilation (ACMV), central mechanical ventilation and air conditioning (central MVAC), Variable Refrigerant Volume (VRV) or split, Air Handling Unit (AHU), Makeup Air Unit (MAU), Primary Air Unit (PAU), and/or Fan Coil Unit (FCU).

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, the connection between each frame connector and the holder can be secured by one or more coupling mechanisms, such as snap fit, magnetic, interlocking mechanisms, etc. For example, each frame connector includes two clips disposed on each arm for snap fit coupling with the corresponding ribs disposed on the holder to secure the connection between the frame connector and the holder.

For example, the pleat spacer in certain example embodiments is a rigid zig-zag shaped wire, but various shapes (e.g., M-shaped), forms (e.g., rod, strip or plate), rigidity and materials can also be used.

For example, in certain embodiments, supporting piece is two pairs of cross pieces pivotally connected with each other in one direction, but other number of pairs of cross pieces can be used, such as one single pair, two, three or more.

For example, in certain example embodiments, the spline is illustrated in a square shape fit for the frame, but it is understood that the spline can be formed from a piece of continuous or multiple pieces of discontinuous elongated, flexible cord. For example, the frame connectors can adopt other reversible mechanisms to connect with the holders, such as slot-in, snap-in, magnetic or inter-locking.

For example, in certain embodiments, the filter is a pleated filter with generally equally spaced multiple folds, but other types of filters may be used, such as flat (non-pleated) filters, or bag-type filters.

1. A reusable filter system, comprising:
(a) an interchangeable filter having a plurality of pleats, each pleat having a pleat height, a pleat width and a cross-section defining a pleat profile, the filter having a first pleated edge generally perpendicular to a direction of pleating and an opposing, second pleated edge, a first side generally parallel to the direction of pleating and an opposing, second side, and an upper pleat tip face and an opposing, lower pleat tip face; and
(b) a reusable frame, comprising:
(i) a first holder sized and shaped to hold the plurality of pleats along the first pleated edge;
(ii) a second holder sized and shaped to hold the plurality of pleats along the second pleated edge;
(iii) a third holder sized and shaped to hold the plurality of pleats along the first side; and
(iv) a fourth holder sized and shaped to hold the plurality of pleats along the second side,
wherein the first, second, third and fourth holders are configured to be reversibly connected with each other to form the reusable frame having a cavity therein to receive the filter when the system is in an assembled state, and
wherein each of the at least one pleat spacer comprising a plurality of spacer elements being sized and shaped to match with the plurality of pleats such as to maintain a spaced, pleat profile of the filter when the system is in the assembled state.

2-8. (canceled)

9. The reusable filter system of claim 1, wherein the system further comprises:
at least one flexible sheet, configured to attach to at least a portion of the upper pleat tip face and/or lower pleat tip face and to extend outward from the first pleated edge and the second pleated edge to form a first pleated edge extension and a second pleated edge extension.

10. The reusable filter system of claim 9, wherein the at least one flexible sheet is at least partially air permeable.

11. The reusable filter system of claim 9 or 10, wherein the at least one flexible sheet is fixedly attached to the filter.

12. The reusable filter system of claim 9, wherein the at least one flexible sheet is a continuous sheet sized and shaped sufficient to cover entire upper pleat tip face or entire lower pleat tip face and to extend outwardly from the first pleated edge and the second pleated edge.

13. The reusable filter system of claim 9, wherein the at least one flexible sheet comprises a first flexible sheet and a second flexible sheet, the first flexible sheet is sized and shaped sufficient to cover entire upper pleat tip face or entire lower pleat tip face and to extend outwardly from the first pleated edge, and the second flexible sheet is sized and shaped sufficient to cover entire upper pleat tip face or entire lower pleat tip face and to extend outwardly from the second pleated edge.

14-18. (canceled)

19. The reusable filter system of claim 1, wherein the reusable frame further comprises a plurality of connectors, each connector is configured to be reversibly connecting two ends of any two of the first, second, third and fourth holders together.

20. The reusable filter system of claim 1, further comprising at least one supporting piece connecting to the reusable frame.

21. The reusable filter system of claim 20, wherein the at least one supporting piece is configured to connect between the third holder and the fourth holder.

22. The reusable filter system of claim 20, wherein the at least one supporting piece is a rigid rod comprising a rectangular, trough or trapezoid cross-section.

23. The reusable filter system of claim 20, wherein the at least one supporting piece is one or more pairs of cross pieces pivotally connected with each other in one direction, each pair of the cross pieces are pivotally connected at a central coupling point, wherein the one or more pairs of cross pieces are configured to connect the third and the fourth holders so that the first and the second holders can be switched between an assembling position and a dissembling position.

24. A reusable frame for an interchangeable pleated filter, the filter having a plurality of pleats, each pleat having a pleat height, a pleat width and a cross-section defining a pleat profile, the filter having a first pleated edge generally perpendicular to a direction of pleating and an opposing, second pleated edge, a first side generally parallel to the direction of pleating and an opposing, second side, and an upper pleat tip face and an opposing, lower pleat tip face, the filter further comprising at least one flexible sheet, configured to attach to at least a portion of the upper pleat tip face and/or lower pleat tip face and to extend outward from the first pleated edge and the second pleated edge to form a first pleated edge extension and a second pleated edge extension, respectively, the reusable frame comprising:
(i) a first holder sized and shaped to hold the plurality of pleats along the first pleated edge;
(ii) a second holder sized and shaped to hold the plurality of pleats along the second pleated edge;
(iii) a third holder sized and shaped to hold the plurality of pleats along the first side; and
(iv) a fourth holder sized and shaped to hold the plurality of pleats along the second sides;
wherein the first, second, third and fourth holders are configured to be reversibly connected with each other to form the reusable frame having a cavity therein to receive the filter when the system is in the assembled state.

25-34. (canceled)

35. The reusable frame of claim 24, wherein the reusable frame further comprises a plurality of connectors, each connector is configured to be reversibly connecting two ends of any two of the first, second, third and fourth holders together.

36. The reusable frame of claim 24, further comprising at least one supporting piece connecting to the frame.

37. The reusable frame of claim 36, wherein the at least one supporting piece is configured to connect between the third holder and the fourth holder.

38. The reusable frame of claim 36 or 37, wherein the at least one supporting piece is a rigid rod comprising a rectangular, trough or trapezoid cross-section.

39. The reusable filter system of claim 36, wherein the at least one supporting piece is one or more pairs of cross pieces pivotally connected with each other in one direction, each pair of the cross pieces are pivotally connected at a central coupling point, wherein the one or more pairs of cross pieces are configured to connect the third and the fourth holders so that the third and the fourth holders can be switched between a spaced position and a proximate position from each other.

40. A method of assembling a reusable filter system for an interchangeable pleated filter, comprising the steps of:
(a) providing the reusable filter system comprising a reusable frame, as claimed in claim 1;
(b) assembling the reusable frame partially or entirely by connecting first, second, third and fourth holders together and installing at least one pleat spacer to the reusable frame;
(c) installing the interchangeable pleated filter to the reusable frame; and
(d) assembling the reusable frame entirely if the same is partially assembled.

41. (canceled)

42. The method of claim 40, wherein the step (b) further comprising:
connecting the first, second, third and fourth holders by a plurality of connectors.

43. The method of claim 40, comprising the steps of:
installing at least one supporting piece to the reusable frame.

44-48. (canceled)

49. The reusable filter system of claim 11, wherein the at least one flexible sheet is fixedly attached to the filter by adhesive, thermal bonding and/or ultrasonic welding.
